(19) United States
(12) Patent Application Publication
(10) Pub. No.: US 2026/0279343 A1
(43) Pub. Date: Sep. 17, 2026

(54) SYSTEM

(71) Applicant: SoftBank Group Corp., Tokyo (JP)

(72) Inventor: Nobuhiro OKUNO, Tokyo (JP)

(73) Assignee: SoftBank Group Corp., Tokyo (JP)

(21) Appl. No.: 19/554,756

(22) Filed: Mar. 3, 2026

Related U.S. Application Data
(60) Provisional application No. 63/771,976, filed on Mar. 14, 2025.

(51) Int. Cl. G10L 15/16; G10L 13/02; G10L 15/02; G10L 15/18; G10L 15/22; G10L 25/63

(52) U.S. Cl. CPC G10L 15/16; G10L 13/02; G10L 15/02; G10L 15/1815; G10L 15/22; G10L 25/63

(57) ABSTRACT

A system includes a processor that is configured to perform a dialog process with an elderly user using natural language processing, collect voice data of the elderly user obtained through the dialog process, analyze the collected voice data to detect a sign of a disease, and provide a notification to at least one of a medical institution, a care service provider, and a security company based on the detected sign of the disease.

### CROSS-REFERENCE TO RELATED APPLICATION

This application claims the benefit of U.S. Provisional Application No. 63/771,976, filed on Mar. 14, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In an aging society, many elderly persons live alone and face increased health risks due to delayed detection of disease and limited daily observation by medical or care professionals. Conventional monitoring systems typically rely on scheduled visits, manual reporting, or wearable sensors that may be intrusive, difficult for elderly persons to use continuously, or insufficient to capture subtle early signs of disease. Furthermore, known dialog systems and smart devices mainly focus on information provision and entertainment, and do not effectively utilize continuous conversational voice data to detect changes in health conditions. As a result, early signs of disease, such as neurological, respiratory, or psychological changes, reflected in alterations of voice characteristics, may remain unnoticed until a serious event occurs. Accordingly, there is a need for a system that can naturally interact with an elderly user in daily life, continuously collect and analyze voice data during such interaction, and automatically notify appropriate third parties, including medical institutions, care service providers, security companies, and family members, when signs of disease are detected, thereby enabling earlier intervention and reducing the burden on caregivers and medical personnel.

### SUMMARY

To solve the above-described problem, an aspect of the present invention provides a system comprising a processor, wherein the processor is configured to perform a dialog process with an elderly user using natural language processing, collect voice data of the elderly user obtained through the dialog process, analyze the collected voice data to detect a sign of a disease, and provide a notification to at least one of a medical institution, a care service provider, and a security company based on the detected sign of the disease. In one embodiment, the processor is configured to provide a conversation to the elderly user in accordance with an interest or a concern of the elderly user by utilizing a generative artificial intelligence technique, and to collect data including voice features comprising at least one of voice tone, pitch, rhythm, speech speed, and volume. In another embodiment, the processor is configured to analyze the voice data by using a machine learning algorithm to detect an abnormal pattern or a change in the voice data and to recognize a sign of a specific disease, and to generate an alert including at least one of details of the detected abnormality, a recommended next step, and location information of the elderly user. By integrating dialog processing, voice feature collection, machine learning-based disease sign detection, and automatic notification in a single system, the invention enables continuous and unobtrusive monitoring of the health condition of the elderly user through daily conversations and facilitates timely communication with relevant parties when abnormal signs are detected.

The term “system” refers to an arrangement of one or more hardware and software components, including at least one processor, that cooperatively execute the functions described in the claims.

The term “processor” refers to any circuit or combination of circuits that is capable of executing instructions, including but not limited to a central processing unit (CPU), a microprocessor, a digital signal processor (DSP), a graphics processing unit (GPU), a microcontroller, or a programmable logic device, whether implemented in a single device or distributed across multiple devices.

The term “dialog process” refers to a sequence of operations in which input representing a user's utterance is received, interpreted, and responded to in natural language, including recognition of the utterance, understanding of its meaning or intent, generation of a response, and output of the response to the user.

The term “natural language processing” refers to a set of techniques or algorithms for automatically processing human language expressed in text or speech, including at least one of speech recognition, language understanding, intent classification, entity extraction, and natural language generation.

The term “voice data” refers to data representing an utterance of the elderly user, including at least one of raw audio signals, digitized audio samples, and derived acoustic features representing characteristics of the utterance.

The term “elderly user” refers to a human user who is of an age at which age-related health risks are considered significant, such as a person of advanced age who is a subject of health monitoring in the context of the present invention.

The term “sign of a disease” refers to an indication or clue that suggests the possible presence, onset, or progression of a physical or mental health condition, which is inferred from analysis of voice data, including but not limited to changes in tone, pitch, rhythm, speech speed, or volume.

The term “medical institution” refers to an organization or facility that provides medical services, including but not limited to hospitals, clinics, medical centers, or other healthcare providers.

The term “care service provider” refers to an individual or entity that supplies care-related services to the elderly user, including but not limited to home-care agencies, nursing service providers, or long-term care facilities.

The term “security company” refers to an organization that provides security or monitoring services for the safety of the elderly user or the user's residence, including but not limited to emergency response services or home security monitoring services.

The term “generative artificial intelligence technique” refers to an artificial intelligence method or model that generates new content, such as text, audio, or dialog responses, based on input data or prompts, including but not limited to large language models, sequence-to-sequence models, and other generative models.

The term “conversation” refers to an exchange of utterances between the system and the elderly user, in which the system provides responses in natural language that are contextually related to the user's utterances or interests.

The term “voice features” refers to measurable parameters that characterize the acoustic properties of the elderly user's voice, including at least one of voice tone, pitch, rhythm, speech speed, and volume.

The term “voice tone” refers to a qualitative or quantitative characteristic of the user's voice related to timbre, emotional expression, or spectral distribution, which may reflect mood or physiological state.

The term “pitch” refers to a perceived or measured fundamental frequency of the user's voice and its variations over time during an utterance.

The term “rhythm” refers to temporal patterns in the user's speech, including timing of syllables, pauses, and stress patterns across an utterance.

The term “speech speed” refers to the rate at which the elderly user speaks, including at least one of the number of syllables, words, or phonemes per unit time.

The term “volume” refers to a level of loudness or amplitude of the user's voice, typically represented by an acoustic intensity or sound pressure level.

The term “machine learning algorithm” refers to an algorithm or model that is trained on data to automatically discover patterns or relationships and to make predictions or classifications regarding new data, including but not limited to neural networks, support vector machines, decision trees, random forests, and ensemble methods.

The term “abnormal pattern” refers to a pattern in the voice data or voice features that deviates from a normal or baseline pattern associated with the elderly user or with a healthy population, as determined by the machine learning algorithm or statistical analysis. The term “change in the voice data” refers to a variation over time in one or more voice features, such as tone, pitch, rhythm, speech speed, or volume, that differs from a previously observed pattern or baseline for the elderly user.

The term “specific disease” refers to a particular medical condition or class of conditions, including but not limited to neurological, respiratory, cardiovascular, or psychological disorders, whose potential presence may be inferred based on analysis of the voice data. The term “alert” refers to a message or signal generated by the system to indicate detection of a sign of a disease or an abnormal pattern, and intended to prompt attention or action by at least one of a medical institution, a care service provider, a security company, or a family member.

The term “details of the detected abnormality” refers to information that describes characteristics of the abnormal pattern or change identified in the voice data, including which voice features are affected, the magnitude of deviation, and any relevant temporal or contextual information.

The term “recommended next step” refers to guidance generated by the system regarding a suggested action following detection of a sign of a disease, including but not limited to scheduling a medical examination, contacting a care provider, or performing additional monitoring.

The term “location information of the elderly user” refers to data indicating a physical position of the elderly user, including at least one of a home address, GPS coordinates, or other location identifiers associated with the user's environment.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

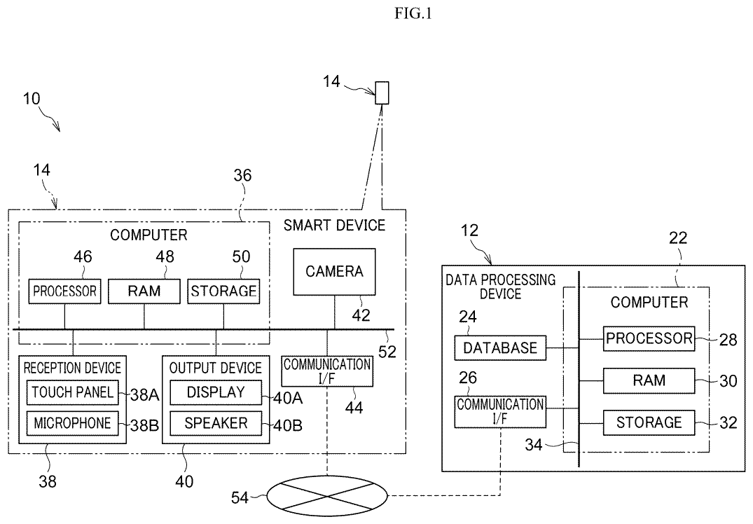

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

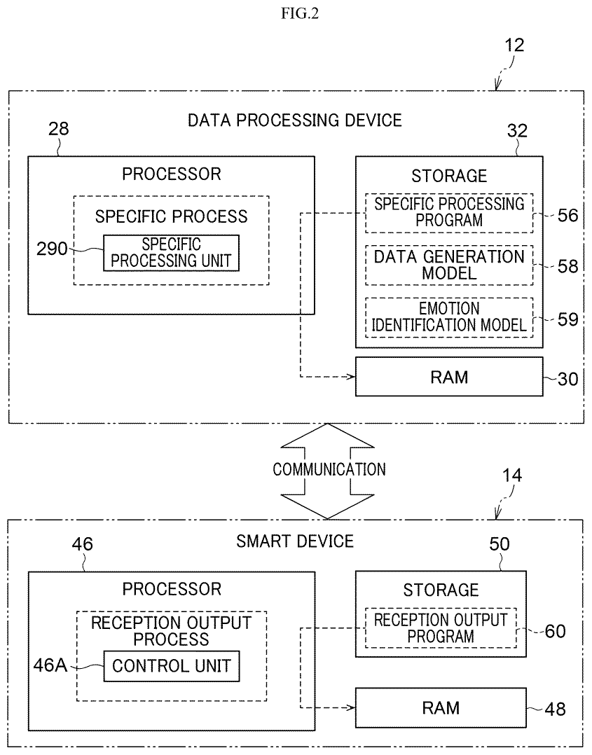

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems and health-monitoring systems suffer from several technical limitations when deployed for continuous monitoring of elderly users through speech interaction. A typical conversational agent executes speech recognition and response generation independently of any long-term analysis of voice characteristics, and therefore fails to utilize rich acoustic feature streams as systematic input for health-related anomaly detection. As a result, large amounts of time-series audio data are either discarded or processed in an ad-hoc, non-integrated manner, which leads to inefficient use of computing resources and limited diagnostic sensitivity.

Further, existing server-side analysis pipelines generally rely on static rule-based thresholds or narrowly scoped classifiers that are not tightly coupled with the dialog flow. They do not maintain a unified, processor-implemented pipeline that (i) extracts structured voice feature values during normal dialog operation, (ii) aggregates those feature values over time, (iii) applies machine learning-based time-series analysis, and (iv) dynamically adapts alert generation policies per user. This fragmented architecture increases latency, requires redundant data transfers, and complicates synchronization between dialog content and diagnostic context.

Additionally, conventional use of generative AI models in dialog systems is typically limited to producing conversational responses. Such systems do not exploit prompt-driven generative models as part of the internal processing pipeline to transform raw numerical analysis results into role-specific, machine-generated explanatory texts for both experts and non-experts. As a consequence, the processor must maintain complex, hand-coded formatting and explanation logic, reducing scalability and making it difficult to tailor outputs to different recipients without significant additional program code.

Moreover, many known systems do not incorporate dialog policy information, user attributes, and long-term voice trends into the prompt sentences supplied to the generative AI model. This leads to responses that are not consistently adapted to cognitive needs of elderly users, and prevents systematic generation of structured, machine-interpretable alerts and explanations. The lack of a unified, processor-configured mechanism for generating and consuming such prompt sentences reduces the technical efficiency of the overall system and impairs its ability to provide timely, targeted notifications.

Accordingly, there is a need for an improved computer-implemented system and server that integrate dialog processing, acoustic feature extraction, machine learning-based state analysis, and generative AI-based explanation generation into a coordinated processing flow. Such a system should reduce processing redundancy, improve utilization of time-series audio features, and provide a configurable, processor-implemented mechanism for generating adaptive prompts and explanation texts that can be consumed by various client devices and organizations.

The specific processing by the specific processing unit 290 of the data processing device 12 in Example 1 is realized by the following means.

The present invention provides a server comprising a processor and a memory storing instructions that, when executed by the processor, cause the processor to perform dialog processing that generates natural language responses based on user utterances, perform acoustic information collection that, in parallel with the dialog processing, extracts and records voice feature values from acoustic information of the user, perform state analysis that applies a trained discrimination model and time-series analysis to recorded and historical voice feature values to calculate an abnormality index and determine whether a health state of the user is abnormal, perform notification processing that, when a determination result satisfies a predetermined condition, transmits notification information including abnormality contents and recommended response contents to at least one external entity, generate prompt sentences including task descriptions, dialog history information, and user utterance text and supply the prompt sentences to a generative AI model to obtain response texts used in the dialog processing, generate explanation prompt sentences based on analysis results including the abnormality index and time-series transition information and supply the explanation prompt sentences to the generative AI model to obtain expert-oriented and family-oriented explanation texts, and transmit alert messages including the explanation texts via a communication network. This enables an integrated, processor-implemented pipeline that efficiently combines dialog interaction, structured extraction and temporal aggregation of voice feature values, machine learning-based anomaly detection, and prompt-driven generative explanation generation, thereby improving the technical performance, scalability, and adaptability of computer-implemented health monitoring and notification for elderly users.

The term “processor” refers to a hardware computing element, such as a central processing unit or other programmable execution unit, that executes instructions stored in a memory to perform logical operations, calculations, control flows, and data processing for implementing the functions of the system.

The term “dialog processing” refers to processing in which the processor generates natural language responses based on user utterances, including recognizing user input, managing dialog context, selecting response content, and outputting response text or speech. The term “acoustic information” refers to digital audio data representing sound captured from a user, including speech waveforms and any associated sampling information such as sampling rate, bit depth, and channel configuration.

The term “voice feature values” refers to numerical or symbolic parameters extracted from acoustic information, including but not limited to fundamental frequency, sound volume, speech rate, speech rhythm, and voice quality stability, which are used for analysis of a user's vocal characteristics.

The term “acoustic information collection” refers to processing in which the processor, in parallel with dialog processing, acquires acoustic information of a user, extracts voice feature values from the acoustic information, and records the voice feature values in a storage resource.

The term “state analysis” refers to processing in which the processor applies a trained discrimination model and optionally time-series analysis to recorded and historical voice feature values to calculate an abnormality index and determine whether a health state of a user is abnormal or within a normal range.

The term “trained discrimination model” refers to a classification or regression model, obtained through a machine learning training process using labeled or unlabeled data, that receives voice feature values or sequences of such values and outputs scores, probabilities, labels, or other indicators relating to abnormality or health state.

The term “abnormality index” refers to a numerical or categorical measure computed by the state analysis that quantitatively represents a degree of deviation of the user's voice feature values from a normal or reference state and is used to judge presence or absence of a health-related abnormality.

The term “time-series transition information” refers to information indicating temporal changes of voice feature values or abnormality indices over a period, including trends, fluctuations, and patterns across multiple time points.

The term “notification processing” refers to processing in which the processor, based on a determination result of the state analysis that satisfies a predetermined condition, generates and transmits notification information including abnormality contents and recommended response contents to one or more external entities.

The term “notification information” refers to data transmitted to an external entity, including at least abnormality contents indicating a detected abnormal state and recommended response contents indicating a suggested next action or handling, optionally together with time information, user information, and context information.

The term “external entity” refers to an organization, service provider, or device outside the server, including but not limited to a medical-related organization, a life-support providing organization, a monitoring-related organization, and a family terminal.

The term “dialog history” refers to structured information representing past exchanges between a user and the system, including prior user utterances, system responses, timestamps, and context labels, which is used to determine subsequent responses and generate prompt sentences.

The term “task description” refers to textual or symbolic information included in a prompt sentence that instructs a generative AI model regarding a role, objective, style, or constraints for generating a response, explanation, or other output.

The term “prompt sentence” refers to a text string or sequence of tokens that includes at least one of a task description, dialog history information, and user utterance text, and that is input to a generative AI model to control and condition the output produced by the generative AI model.

The term “generative AI model” refers to a trained machine learning model that outputs natural language text or other structured content in response to an input prompt sentence, typically implemented as a neural network such as a transformer-based language model. The term “generative response processing” refers to processing in which the processor constructs a prompt sentence including task descriptions, dialog history information, and user utterance text, inputs the prompt sentence to a generative AI model, and obtains a response text used as a dialog response.

The term “explanation prompt sentence” refers to a prompt sentence generated based on analysis results including an abnormality index and time-series transition information, which instructs a generative AI model to produce explanation texts describing detected abnormalities or trends.

The term “explanation generation processing” refers to processing in which the processor generates one or more explanation prompt sentences based on analysis results and inputs the explanation prompt sentences to a generative AI model to obtain expert-oriented and family-oriented explanation texts.

The term “expert-oriented explanation text” refers to a natural language text generated by the generative AI model that describes analysis results, detected abnormal patterns, and suggested responses in a form suitable for use by a professional, such as a medical practitioner or care provider.

The term “family-oriented explanation text” refers to a natural language text generated by the generative AI model that explains the analysis results and suggested responses in simplified and reassuring language suitable for a non-expert family member.

The term “alert message” refers to a message generated by the processor that includes at least one of an expert-oriented explanation text and a family-oriented explanation text and that is transmitted to an external entity to inform the external entity of a detected abnormal state or recommended response.

The term “transmission control processing” refers to processing in which the processor controls generation, formatting, addressing, and sending of alert messages or notification information through a communication network according to predetermined rules or conditions.

The term “dialog policy information” refers to information specifying one or more dialog behavior constraints or preferences, including user attributes such as being an elderly person and requirements to use easy-to-understand expressions, which is incorporated into a prompt sentence to influence behavior of a generative AI model.

The term “control text” refers to a portion of a prompt sentence that encodes dialog policy information, role instructions, or formatting constraints, and that directs a generative AI model to generate output in a specified style or manner.

The term “speech rate” refers to a voice feature value representing a speed of speech, such as a number of syllables, words, or phonetic units per unit time.

The term “speech rhythm” refers to a voice feature value representing temporal patterns of speech, including timing, duration of segments, and distribution of pauses.

The term “voice quality stability” refers to a voice feature value representing stability of vocal characteristics, including variation in pitch, amplitude, and spectral properties over time, and is indicative of tremor or other irregularities.

The term “reference value” refers to a baseline or normal value for a voice feature or abnormality index, which may be determined per user or per population and is used as a comparison point for detecting variations.

The term “disease sign” refers to a pattern in voice feature values or their time-series variations that is indicative of a possible health condition or abnormality, without constituting a definitive medical diagnosis.

In one embodiment, a server and a terminal cooperate to implement the claimed system. The server includes at least one processor, a memory, a network interface, and a non-transitory storage device. The terminal includes at least one processor, a memory, a microphone, a loudspeaker, a local storage, and a network interface. The terminal is installed in a residence of a user, for example an elderly user, and the server is located in a data center or cloud computing environment.

The terminal executes an operating system such as a mobile operating system or an embedded operating system, and runs an application program that implements dialog processing and acoustic information collection. The server executes a server operating system and runs a set of server-side services that implement state analysis, notification processing, and interaction with a generative AI model.

The terminal acquires acoustic information through the microphone. The terminal digitizes incoming sound using an audio driver of the operating system and stores digitized samples in a buffer of the memory. In one example, the terminal samples audio at 16 kHz with 16-bit linear PCM encoding. The terminal applies pre-processing using a digital signal processing library, which may include noise reduction, echo cancellation, and automatic gain control. The terminal detects voice activity and segments continuous audio streams into utterance units.

The terminal performs speech recognition locally or by invoking a remote speech recognition service. The terminal, when using local recognition, extracts acoustic features such as Mel-frequency cepstral coefficients, log-Mel spectrograms, and pitch contours from the segmented audio. The terminal inputs the features into an acoustic model implemented as a neural network, such as a convolutional-recurrent network or a transformer-based encoder. The terminal decodes output probabilities using a language model to obtain text corresponding to user utterances.

The terminal performs dialog processing by analyzing the recognized text. The terminal uses a natural language processing engine to detect user intent, extract entities such as date and location, and maintain dialog history. The terminal stores dialog history as a structured data object in memory, including an ordered list of user utterances, system responses, timestamps, and dialog state labels. The dialog history is represented, for example, as an array of records, each record including fields for role, text, time, and context tags.

The terminal generates a prompt sentence for a generative AI model. The terminal constructs the prompt sentence by concatenating a task description, dialog policy information, dialog history, and the most recent user utterance. The terminal explicitly encodes that the user is an elderly person and that the response should use simple and polite language. In one example, the terminal generates the following prompt sentence:

“You are a conversational assistant for an elderly person. Using simple and polite language, answer the user's question clearly in 2 or 3 sentences. The user asked: ‘What news do we have today?’.”

In another example, the terminal generates a prompt sentence for weather information: “Based on the elderly user's question, generate a clear and brief answer about today's weather, using easy words and a friendly tone. The user said: ‘How is the weather tomorrow?’.”

The terminal sends the prompt sentence and associated context to the server via a secure communication channel, such as HTTPS over a transport layer security protocol. The terminal encapsulates the prompt sentence in a request message that includes a user identifier, device identifier, and session identifier, enabling the server to maintain association between dialog and state analysis results.

The server receives the request and forwards the prompt sentence to a generative AI model. The server stores the generative AI model as a machine learning service, implemented for example as a transformer-based language model with multiple self-attention layers, feedforward layers, and layer normalization. The server tokenizes the prompt sentence into subword tokens, converts the tokens into embeddings, and processes the sequence through the transformer layers. The server uses positional encodings to represent token positions and applies multi-head self-attention to compute contextualized representations.

The server decodes output tokens using a sampling strategy, such as top-p sampling with a predefined temperature parameter. The server concatenates generated tokens into a response text. The generative AI model may have been trained on a large text corpus using a language modeling objective that minimizes cross-entropy loss between predicted tokens and ground-truth tokens. During training, the server updates model parameters such as weights and biases using gradient descent or variants thereof, for example Adam optimization, based on backpropagation of error signals.

The server returns the response text to the terminal, which then performs text-to-speech synthesis. The terminal uses a text-to-speech engine to convert the response text into an audio waveform. The terminal generates phonetic units from graphemes, assigns prosody parameters such as pitch contour and duration, and synthesizes an audio signal through a vocoder. The terminal outputs the synthesized speech through the loudspeaker so that the user perceives natural spoken feedback.

In parallel with speech recognition, the terminal performs acoustic information collection. The terminal extracts voice feature values from the same digitized audio used for recognition. The voice feature values include fundamental frequency, amplitude envelope, spectral moments, jitter, shimmer, speech rate, and measures of voice quality stability. The terminal computes these values for each utterance and aggregates them over a session. The terminal represents the voice feature values as a vector, where each dimension corresponds to a feature such as mean pitch, pitch variance, average energy, articulation rate, proportion of pauses, and spectral slope.

The terminal associates each voice feature vector with metadata including user identifier, timestamp, and dialog context type. The terminal stores the feature vector and metadata in a structured record in local memory and transmits the record to the server periodically or upon completion of an utterance. The transmission uses compressed numerical formats to reduce communication load, thus lowering network bandwidth utilization compared to sending raw audio.

The server receives the voice feature records and stores them in a time-series database in the storage device. The server organizes the data per user and per time, using keys that include user identifier and observation time. The server maintains baseline statistics per user, such as long-term averages and standard deviations of each feature. The server periodically updates these baseline values as new data arrives.

The server performs state analysis using a trained discrimination model. In one embodiment, the server implements the model as a recurrent neural network, such as a long short-term memory network, that receives a sequence of voice feature vectors as input and outputs abnormality indices. The server processes sequences of length N, where N corresponds to a time window such as several days or weeks. The server normalizes each feature dimension by subtracting the user-specific baseline and dividing by the baseline standard deviation, thereby focusing on deviations from individual norms rather than population averages.

The server propagates the normalized sequence through the recurrent layers to obtain a hidden representation of temporal patterns. The server applies a dense output layer to map the hidden representation to one or more abnormality indices, such as a tremor index, depression prosody index, and overall risk index. The server uses predefined thresholds, which may be adaptive per user, to determine whether each index indicates an abnormal condition. The server stores the abnormality indices and associated flags in the database.

In another embodiment, the server uses a transformer-based time-series model or a gradient boosting model as the trained discrimination model. The server can select between models depending on computing resources and required latency. The server may implement ensemble techniques that combine outputs of multiple models to reduce variance and improve robustness.

The server uses machine learning training procedures to obtain the trained discrimination model. Before deployment, the server accesses a labeled dataset containing historical voice feature sequences and labels indicating presence or absence of specific health-related conditions. The server partitions data into training and validation sets. The server initializes model parameters randomly and iteratively updates the parameters by minimizing a loss function, such as binary cross-entropy or mean squared error, using gradient-based optimization. The server may apply regularization techniques, such as dropout or weight decay, to prevent overfitting. The server may also use data augmentation techniques at the feature level, such as random time warping or adding small noise to feature values, to improve generalization.

The server executes state analysis in a manner that is not a mere automation of human assessment. The server analyzes high-dimensional voice feature sequences at a temporal resolution and in a multivariate space that is impractical for human observers to process manually. The server maintains per-user baselines and dynamically adjusts detection thresholds based on statistical distributions and learning outcomes. This configuration enables improved sensitivity to subtle changes while controlling false positives, thus representing an improvement in computational analysis of time-series health signals.

The server, after computing abnormality indices, generates explanation prompt sentences to obtain human-readable explanations. The server composes an explanation prompt sentence that includes numerical values of abnormality indices, summaries of time-series transitions, and instructions describing target audience and constraints. For example, the server generates the following explanation prompt sentence for professional recipients:

“You are assisting caregivers. Based on the following voice analysis scores and trends for an elderly person, explain in simple professional English what abnormal patterns were detected and suggest reasonable next steps without making a final diagnosis. Scores: tremor_index=0.82 (baseline 0.30), loudness_index=0.25 (baseline 0.65); Trend: steady increase in tremor over 14 days, reduction in average loudness over 10 days.”

For family members, the server generates an explanation prompt sentence such as: “Explain in kind and reassuring language that recent analysis of an elderly person's voice shows some changes that may require a non-urgent medical check-up. Avoid medical jargon and describe the situation in 2 or 3 sentences.”

The server inputs these explanation prompt sentences into the same generative AI model or into dedicated generative models configured for explanatory tasks. The server obtains expert-oriented explanation texts and family-oriented explanation texts. The server thus offloads complex natural language formatting and tailoring onto the generative AI model, while retaining structured numerical analysis within the state analysis logic.

The server executes notification processing when abnormality indices or patterns satisfy predetermined conditions. The server generates alert messages that include the explanation texts, relevant indices, and identifiers needed by external entities. The server formats these alert messages for different channels, such as electronic mail messages, short text messages, or push notifications. The server sends the messages through the network interface, using protocols appropriate to each channel.

The server and the terminal collectively achieve technical improvements over conventional systems. The server reduces communication load by transmitting compressed feature vectors instead of raw audio streams, thereby reducing bandwidth usage and latency. The terminal performs early feature extraction, which lowers server computation load and enables faster, near-real-time analysis. The state analysis uses specialized neural network architectures for time-series, which process long sequences more efficiently than simple window-based scanning. The generative AI model is driven by structured prompt sentences that encode dialog policy information and analysis results, reducing the need for hand-crafted templates and rule-based text generation. This arrangement decreases code complexity, lowers maintenance costs, and improves scalability.

The server enforces data structures and processing flows that are specifically designed for technical performance. Voice feature vectors are stored in fixed-length arrays indexed by feature identifiers, enabling vectorized computation on processors and accelerators.

Time-series sequences are stored in contiguous memory regions to improve cache locality during neural network inference. The server applies batching of multiple sequences in a single inference call to the discrimination model and the generative AI model, improving throughput on hardware accelerators such as graphics processing units.

The system differs from mere business process automation because the core processing is focused on low-level signal features, high-dimensional numerical analysis, and tight integration with machine-oriented models. The server uses trained models that operate according to learned parameter values and non-linear transformations, rather than following explicit human rules or guidelines. The detection of abnormality indices and generation of tailored explanations emerge from model architectures and training data, not from static rule sets. This leads to improved detection accuracy and adaptability compared with systems that simply encode human decision trees.

The server and the terminal are configured to handle variations in user behavior and environmental noise. The terminal adapts pre-processing parameters based on noise estimates, and the server adjusts thresholds based on long-term patterns. This adaptive, model-based configuration allows the system to maintain detection accuracy over extended periods without manual recalibration. The terminal and server thus operate as a coupled, self-optimizing system that refines baselines and processing behavior as more data accumulate.

In another embodiment, the terminal executes a smaller generative AI model locally, such as a distilled transformer model with fewer layers and parameters, to generate responses without server round-trips for certain queries. The server still performs state analysis and explanation generation for health monitoring, while the terminal handles routine conversational tasks. This division of labor reduces network latency and improves user experience while preserving centralized analysis for health-related functions.

In another embodiment, the server or the terminal includes a graphical user interface that displays trends of selected voice feature values and abnormality indices to authorized users. The display component retrieves data from the storage device and renders charts showing time-series values, thresholds, and alerts. Although visualization itself is not central to state analysis, the same data structures and processing flow support both automated decision making and human review.

In a further embodiment, the server employs different generative AI models for dialog responses and for explanations. For example, the server may use a larger, general-purpose language model for dialog tasks and a smaller, fine-tuned model specialized for medical explanation tasks. The server routes prompt sentences to the appropriate model based on tags in the prompt sentence and the target audience. This modular architecture allows separate updates and training for different functions.

The server and the terminal can be implemented on various hardware platforms. The server may use general-purpose processors and hardware accelerators arranged in clusters, while the terminal may use a microcontroller or system-on-chip platform. The described processing, data structures, and algorithms can be adapted to these different platforms without changing the essential behavior of dialog processing, acoustic information collection, state analysis, generative explanation, and notification processing.

The system, by integrating dialog processing, feature extraction, advanced time-series machine learning, and prompt-driven generative explanation in a single, coherent architecture, provides a concrete technical solution. The server and the terminal together improve processing speed by distributing tasks, improve precision of anomaly detection by using trained discrimination models on normalized voice features, and reduce communication overhead by transmitting compact data representations. These technical effects arise from the specific arrangement of components, data structures, and algorithms described above, rather than from any abstract idea or generic automation of human activities.

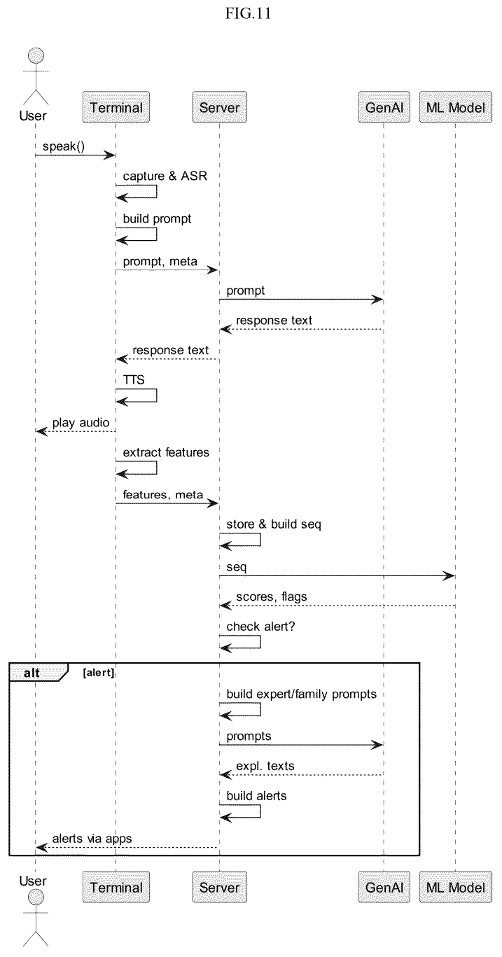

The following describes the processing flow using FIG. 11.

### Step 1:

The user speaks toward the terminal.

The input is analog speech sound produced by the user. The terminal receives the sound through the microphone and converts it into digital audio samples using an analog-to-digital converter at a predetermined sampling rate and bit depth. The terminal stores the resulting audio frames in a memory buffer as a sequence of numeric values representing waveform amplitudes.

### Step 2:

The terminal performs audio pre-processing.

The input is the buffered digital audio samples. The terminal applies digital signal processing operations, including noise reduction, echo cancellation, and automatic gain control, to the samples. The terminal detects regions of speech using a voice activity detector, segments the continuous signal into utterance units, and outputs a cleaned, segmented audio stream for each utterance as a sequence of frames.

### Step 3:

The terminal performs speech recognition.

The input is the cleaned, segmented audio stream. The terminal computes acoustic features such as Mel-frequency cepstral coefficients and log-Mel spectrogram values from each audio frame, forming a feature matrix. The terminal inputs this matrix into a local acoustic model implemented as a neural network and performs forward propagation to obtain probability distributions over phonetic units or subword tokens. The terminal applies a decoding algorithm with a language model to convert the probabilities into a text string, and outputs recognized text representing the user's utterance.

### Step 4:

The terminal performs dialog understanding.

The input is the recognized text and a stored dialog history object. The terminal uses a natural language processing module to parse the text, identify intent labels, and extract entities such as dates, locations, or topics. The terminal updates the dialog history by appending a new record that includes the user's text, detected intent, and timestamp. The terminal outputs an updated dialog state that will be used for response generation.

### Step 5:

The terminal constructs a prompt sentence for a generative AI model.

The input is the updated dialog state, including the latest user utterance, past system responses, and dialog policy information indicating that the user is an elderly person. The terminal selects an appropriate task description and dialog guidance rules, and concatenates them with relevant elements of the dialog history and the latest user text. The terminal performs string formatting and escaping, if necessary, to produce a single coherent prompt sentence. The terminal outputs a prompt sentence such as: “You are a conversational assistant for an elderly person. Using simple and polite language, answer the user's question clearly in 2 or 3 sentences. The user asked: ‘What news do we have today?’.”

### Step 6:

The terminal sends the prompt sentence to the server.

The input is the constructed prompt sentence and identification metadata such as user ID and device ID. The terminal encapsulates these data into a request message, serializes the message into a network format, and transmits it via a secure protocol over the network interface. The output is a network request received by the server that contains the prompt sentence and associated identifiers.

### Step 7:

The server performs generative response processing using a generative AI model. The input is the prompt sentence and the identification metadata. The server tokenizes the prompt sentence into discrete tokens, maps tokens to numerical embeddings, and processes the sequence through a transformer-based language model stored in memory. The server performs multiple layers of self-attention and feedforward computation to generate contextualized hidden states, then decodes output tokens using a sampling strategy. The server concatenates the output tokens into a response text, such as a news summary, and outputs the response text together with metadata such as generation time.

### Step 8:

The server returns the response text to the terminal.

The input is the generated response text and metadata. The server places these data into a response message, serializes the message, and sends it through the network interface back to the terminal. The output is a network response that contains the natural language response text for the current dialog turn.

### Step 9:

The terminal performs text-to-speech synthesis.

The input is the response text received from the server. The terminal passes the text into a text-to-speech engine, which converts characters into phonetic units, assigns prosodic parameters such as pitch, speed, and pause positions, and generates a synthetic speech waveform using a vocoder algorithm. The terminal outputs an audio signal that is played through the loudspeaker so that the user hears the system's spoken response.

### Step 10:

The terminal performs voice feature extraction for health monitoring.

The input is the cleaned audio stream of the user's utterance obtained in Step 2. The terminal computes quantitative feature values such as mean and variance of fundamental frequency, average energy, jitter, shimmer, speech rate, proportion of silence, and spectral slope. The terminal aggregates these values into a fixed-length feature vector and associates the vector with a timestamp, user ID, and dialog context type. The terminal outputs a structured record containing the feature vector and metadata.

### Step 11:

The terminal transmits voice feature records to the server.

The input is the structured record with voice feature values and metadata. The terminal encodes the numeric vector into a compact binary or JSON representation and packages it with identifiers in a monitoring data message. The terminal sends the message over the network to the server using a secure communication protocol. The output is a monitoring data packet received by the server.

### Step 12:

The server stores and organizes time-series feature data.

The input is the monitoring data packet that includes the feature vector and metadata. The server validates the identifiers, extracts the feature vector, and inserts it into a time-series data store under keys corresponding to the user ID and timestamp. The server updates per-user baseline statistics by recalculating running means and variances for each feature dimension using the newly received data. The server outputs updated storage records and baseline parameters for the user.

### Step 13:

The server prepares normalized sequences for state analysis.

The input is the newly stored feature vector and a set of past feature vectors for the same user over a predefined time window. The server constructs a chronological sequence of feature vectors, aligns them by time, and applies normalization by subtracting the user-specific baseline mean and dividing by the baseline standard deviation for each feature dimension. The server outputs a normalized time-series matrix that will be used as input to the trained discrimination model.

### Step 14:

The server executes the trained discrimination model for state analysis.

The input is the normalized time-series matrix. The server feeds the sequence into a trained neural network, such as a recurrent or transformer-based model, and runs forward propagation to obtain hidden representations and final output values. The server computes abnormality indices, such as a tremor index and a prosody change index, by applying activation functions and linear transformations to the final hidden state. The server compares these indices to predetermined or adaptive thresholds and sets flags indicating normal or abnormal conditions. The server outputs the abnormality indices, flags, and any intermediate statistics required for explanation.

### Step 15:

The server determines whether notification is required.

The input is the set of abnormality indices, associated flags, and user-specific notification rules stored in the database. The server evaluates logical conditions that combine the indices, threshold exceedances, and recent trend patterns, for example detecting sustained increase in a tremor index over multiple days. If the conditions satisfy alert criteria, the server marks the situation as requiring notification and records the type and urgency. The server outputs a decision result indicating whether to create an alert and what category of recipients should be notified.

### Step 16:

The server constructs an explanation prompt sentence for expert recipients.

The input is the abnormality indices, time-series trend summaries, and the decision result indicating that notification is needed for professional entities. The server formats these numerical values into descriptive text segments and concatenates them with explicit instructions for the generative AI model. The server generates a prompt sentence such as: “You are assisting caregivers. Based on the following voice analysis scores and trends for an elderly person, explain in simple professional English what abnormal patterns were detected and suggest reasonable next steps without making a final diagnosis. Scores: tremor_index=0.82 (baseline 0.30), loudness_index=0.25 (baseline 0.65); Trend: steady increase in tremor over 14 days, reduction in average loudness over 10 days.”

The server outputs this explanation prompt sentence for use by the generative AI model.

### Step 17:

The server constructs an explanation prompt sentence for family recipients.

The input is the same analysis results and a rule indicating that the user's family should also be notified. The server produces a simplified instruction text and combines it with a short description of the observed changes. The server creates a prompt sentence such as: “Explain in kind and reassuring language that recent analysis of an elderly person's voice shows some changes that may require a non-urgent medical check-up. Avoid medical jargon and describe the situation in 2 or 3 sentences.”

The server outputs this family-oriented explanation prompt sentence.

### Step 18:

The server obtains explanation texts from the generative AI model.

The input is the expert-oriented explanation prompt sentence and the family-oriented explanation prompt sentence. The server forwards each prompt sentence to the generative AI model, tokenizes the text, and runs inference to generate output tokens. The server concatenates the tokens into two explanation texts: one tailored for professional readers and one for family members. The server outputs the explanation texts along with metadata indicating the intended audience.

### Step 19:

The server composes alert messages for different channels.

The input is the explanation texts, abnormality indices, user identifiers, and recipient configuration data. The server constructs structured alert messages, embedding the expert-oriented explanation text in messages to medical-related or monitoring-related organizations, and embedding the family-oriented explanation text in messages to family terminals. The server adds headers, subject lines, or notification titles as required by each channel, and includes key values such as risk level and timestamps. The server outputs fully formatted alert message objects ready for transmission.

### Step 20:

The server transmits alert messages to external entities.

The input is the alert message objects and channel configuration information. The server selects communication protocols, such as email, SMS, or push notification, for each recipient type, and uses the network interface to send the alerts. The server handles transmission errors by applying retry policies or logging failures. The server outputs transmitted notifications that reach medical-related organizations, life-support providers, monitoring-related organizations, and family terminals.

### Step 21:

The user and external entities react to alerts, and the terminal resumes dialog.

The input is the notifications received by external devices and any subsequent user interaction. The user or caregivers may take actions based on the received explanations, such as scheduling a check-up. Independently, the terminal continues to present dialog prompts and respond to the user's speech in the same manner as Steps 1 through 9. The terminal further collects voice feature data during new conversations, and the server incorporates the new data into subsequent iterations of Steps 12 through 20, thereby closing the loop between dialog interaction, health analysis, and notification.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional health monitoring systems that utilize voice information in care facilities typically treat speech as a simple input channel for command recognition or question answering. Such systems often rely on rule-based responses and manually designed thresholds on a small set of acoustic metrics. As a result, they suffer from several technical limitations in the field of computer technology.

First, conventional dialog systems are not designed to dynamically adapt their conversational behavior and health analysis logic based on long-term, user-specific acoustic feature profiles. Speech recognition and dialog management are usually performed on a per-utterance basis, without constructing or maintaining a time-series baseline of acoustic features, such as pitch, intensity, and speaking rate, for each individual user. This limits the system's ability to detect subtle, gradual changes in a user's voice that may indicate an emerging health issue, and leads to poor performance of automated anomaly detection.

Second, existing systems do not effectively integrate generative AI models into the core processing pipeline in a way that improves the functioning of computing components themselves. In many cases, generative models are used merely as optional front-end assistants. There is no standardized, machine-oriented mechanism for constructing prompt sentences that encode internal state information (such as disease risk indices, user attributes, and alert metadata) and for using the output of the generative model as structured, machine-consumable explanation data. Consequently, the system cannot systematically leverage generative models to transform raw analytic results into consistent, contextualized notification content, nor can it use such models to automatically adapt and refine notification behavior. Third, conventional architectures frequently lack a unified processor-controlled mechanism that coordinates dialog processing, acoustic feature extraction, anomaly scoring, and notification generation under user consent constraints. Typical implementations scatter these responsibilities across disparate modules or services without centralized enforcement of consent and without a clear separation between health analysis execution and data storage/anonymization. This can lead to complex and error-prone control logic, difficulties in ensuring compliance with changing consent conditions, and inefficient use of computational resources for data that may no longer be authorized for analysis.

Fourth, many notification subsystems are designed with fixed templates or static rule sets. They do not compute multi-dimensional risk indices derived from deviations from a learned baseline profile, and they do not dynamically tailor the content, priority, and target category of alerts based on a combination of analytic results and historical notification outcomes. This limits the system's ability to produce technically optimized alert messages that are both actionable for various recipients and aligned with system-level performance objectives, such as reducing false positives and improving triage efficiency.

Accordingly, there is a need for improved computer-implemented techniques that: (i) build and maintain user-specific, time-series acoustic feature baselines, (ii) compute disease risk information by comparing new feature data against such baselines through machine learning models, (iii) generate and use structured prompt sentences to drive generative AI models for producing explanation data and personalized dialog responses in a machine-orchestrated manner, and (iv) centrally control storage, analysis, notification, and anonymization operations in accordance with consent, in order to enhance the technical performance, robustness, and adaptability of health monitoring and dialog systems in care environments.

The specific processing by the specific processing unit 290 of the data processing device 12 in Application Example 1 is realized by the following means.

The present invention provides a server comprising a processor and a memory storing instructions that, when executed by the processor, cause the processor to perform dialog processing to conduct a natural language dialog with a user by converting input audio information into character information, executing natural language processing on the character information, generating response character information, and converting the response character information into audio information for output, to generate, during the dialog processing, feature sequences based on time information for audio information obtained from the user, to extract acoustic feature values from the feature sequences, and to store the acoustic feature values for each user and for each time series in a storage unit, to compare stored acoustic feature values with past acoustic feature values, to use a machine learning model to calculate an abnormality degree related to a health condition of the user, and to generate disease risk information based on the abnormality degree, to generate notification information data to be presented to a notification target based on the disease risk information and attribute information, behavior information, and location information related to the user, to generate a prompt sentence including at least the disease risk information and the attribute information related to the user, to input the prompt sentence to a generative AI model, and to acquire explanation character information from the generative AI model, to generate notification messages for a care service provider terminal and a family terminal based on the explanation character information and the notification information data, and to transmit the notification messages via a communication network, and to control execution availability of the storage of the acoustic feature values and the calculation of the abnormality degree based on consent information from the user or from an associated person, and to perform deletion or anonymization of stored information in accordance with a change of the consent information. This enables the computing system to automatically construct and update user-specific acoustic baselines, to compute and interpret disease risk information using machine learning models, to orchestrate generative AI models through structured prompt sentences for generating machine-consumable explanation and dialog content, and to centrally manage analysis, notification, and data handling operations under consent constraints, thereby improving the technical performance, reliability, and adaptability of computer-based health monitoring and dialog processing in care environments.

The term “processor” refers to a hardware computation element, such as a central processing unit, graphics processing unit, or other programmable logic device, configured to execute instructions to perform one or more functions described in this specification. The term “memory” refers to any non-transitory storage medium, including semiconductor memory, magnetic storage, optical storage, or other computer-readable medium, configured to store instructions and data for use by the processor.

The term “dialog processing” refers to a sequence of computer-implemented operations that receive audio information from a user, convert the audio information into character information, perform natural language processing on the character information, generate response character information, and convert the response character information into audio information for output.

The term “audio information” refers to digital data representing sound, including sampled waveform data or encoded audio data, obtained from a user through an input device such as a microphone.

The term “character information” refers to digital data representing linguistic content in a symbolic form, including text encoded in a character set, used for natural language processing and generation.

The term “natural language processing” refers to a set of algorithmic operations, including parsing, tokenization, intent detection, entity extraction, and semantic analysis, that are performed by a computing device to interpret or generate human language in textual form. The term “response character information” refers to character information generated by the processor as an output of the dialog processing, intended to be converted into audio information and presented to the user as a response in a dialog.

The term “feature sequence” refers to a time-ordered series of feature values derived from audio information over a time axis, where each element of the series corresponds to one or more acoustic feature values computed for a time segment.

The term “time information” refers to data indicating temporal positions or intervals associated with audio information, including timestamps, frame indices, or durations, used to generate feature sequences.

The term “acoustic feature value” refers to a numeric or symbolic value representing a characteristic of audio information, including but not limited to pitch, intensity, spectral characteristics, formant frequencies, jitter, shimmer, rhythm, and speaking rate.

The term “storage unit” refers to a logical or physical component, implemented using the memory or a storage device, that is configured to store acoustic feature values, character information, and other data in association with user identifiers and time information. The term “abnormality degree” refers to a quantitative measure computed by a machine learning model that indicates a degree of deviation of current acoustic feature values from a reference pattern or baseline, in relation to a health condition.

The term “disease risk information” refers to data representing a likelihood, level, or classification of a health-related risk associated with a user, generated based on the abnormality degree and optionally including risk scores, risk categories, or identified potential conditions.

The term “attribute information” refers to data describing static or relatively slowly changing characteristics of a user, including age, gender, medical background, preferences, or registration information.

The term “behavior information” refers to data describing dynamic actions or states of a user, including activity patterns, interactions with systems, participation in events, or usage history. The term “location information” refers to data indicating a physical position of a user or a device associated with the user, including room identifiers, zone identifiers, coordinates, or other position-related identifiers determined by a location system.

The term “notification information data” refers to computer-readable data that define content and parameters of a notification, including at least disease risk information, attribute information, behavior information, location information, target recipient categories, recommended actions, and notification priority.

The term “notification target” refers to an entity or class of entities to which a notification is intended to be delivered, including care service providers, family members, or monitoring personnel.

The term “prompt sentence” refers to character information that encodes at least input conditions, context information, and instructions for a generative AI model, and that is provided as an input to the generative AI model to cause the model to generate corresponding output character information.

The term “generative AI model” refers to a machine learning model, such as a large language model or other generative model, configured to receive input character information, including a prompt sentence, and generate output character information that follows patterns learned from training data.

The term “explanation character information” refers to character information generated by the generative AI model in response to a prompt sentence, the character information including explanatory content regarding disease risk information, alerts, or dialog responses for use by human recipients and system components.

The term “notification message” refers to a data structure or formatted content that includes at least part of the notification information data and explanation character information, and that is transmitted to a terminal associated with a notification target through a communication network.

The term “care service provider terminal” refers to an information processing device, such as a workstation, portable terminal, or communication device, used by personnel who provide care services, and configured to receive and display notification messages.

The term “family terminal” refers to an information processing device, such as a personal communication terminal or computing device, associated with a family member or other associated person of the user, and configured to receive and display notification messages. The term “communication network” refers to a wired or wireless data communication infrastructure, including local networks and wide area networks, configured to transmit data between the server and one or more terminals.

The term “consent information” refers to data indicating a permission status or preference of a user or associated person regarding collection, storage, analysis, or use of audio information, acoustic feature values, and related health information.

The term “baseline profile” refers to a data representation of typical or reference acoustic feature patterns for a user, generated from acoustic feature values over a predetermined period, and used to evaluate deviations in subsequent feature values.

The term “risk index” refers to a quantitative or categorical indicator computed from acoustic feature values and baseline profiles, representing a degree of risk for one or more health-related conditions.

The term “alert information” refers to data representing a structured alert to be generated for one or more notification targets, including at least a classification of notification targets, recommended response actions, severity or priority level, and references to underlying risk indices.

The term “past notification results” refers to data describing outcomes or responses associated with previously generated notifications, including whether an alert was acknowledged, what follow-up actions were taken, and any confirmed diagnoses or non-issues.

The term “execution availability” refers to a control state that determines whether specific processing operations, such as storage of acoustic feature values or calculation of an abnormality degree, are permitted to be executed by the processor based on configured conditions, including consent information.

The term “deletion or anonymization of stored information” refers to processing operations that respectively remove stored data from storage or transform stored data into a form that cannot be associated with an identifiable individual, in accordance with changes in consent information or policies.

In one embodiment, a system includes a server, one or more terminals, and at least one user, such as an elderly person residing in a care facility. The server includes a processor and a memory. The processor executes stored instructions to implement dialog processing, acoustic feature extraction and storage, health state analysis using machine learning models, prompt sentence generation, interaction with a generative AI model, notification generation, and consent-based data control. The terminals each include at least one processor, a microphone, a speaker, a display unit, and a communication interface. The terminals operate as input/output devices for the user and communicate with the server over a wired or wireless communication network.

The terminal uses its processor, audio driver, and microphone to acquire audio information from the user. The terminal converts the analog voice signal into digital audio information, for example, 16-bit linear PCM at 16 kHz sampling, using an audio codec implemented in a low-level library such as an operating-system audio stack. The terminal executes an automatic speech recognition program, which may be implemented using a speech recognition software development kit or a local neural network model, to convert the audio information into character information. The terminal optionally performs noise suppression, echo cancellation, and voice activity detection using a digital signal processing library. These operations improve recognition accuracy and reduce the amount of data to be transmitted to the server, thereby reducing communication load and improving response latency.

The server receives the character information and associated metadata, such as timestamps and device identifiers, from the terminal via a secure communication protocol such as HTTPS. The server stores the received character information temporarily in a data structure, such as a record in a relational database table that associates a session identifier, user identifier, and the text content. The server then performs natural language processing using a natural language processing engine implemented by a sequence of algorithms, such as tokenization, part-of-speech tagging, syntactic parsing, and intent classification. The server uses these algorithms to determine an intent label, such as “request_activity_schedule” or “request_health_status,” and to extract semantic entities, such as date expressions and activity names.

The server uses the result of the natural language processing to prepare a response. The server accesses a data repository that stores attribute information of the user, such as age group, preference categories, and language settings, and facility schedule information, such as daily activity time slots and locations. The server selectively filters these data structures using query conditions derived from the intent and entities. The server then constructs a prompt sentence for a generative AI model. The server encodes necessary elements, including the user's question, the relevant schedule information, and constraints on style and length, into a single text string, for example:

“You are an assistant in a care facility. An elderly resident asked: ‘What activities are there today?’. Use the following schedule data to generate a short, friendly spoken response that the resident can easily understand. Respond in one or two simple sentences.”

The server provides the prompt sentence to the generative AI model. In one implementation, the generative AI model is a transformer-based neural network, such as a multi-layer sequence-to-sequence model with self-attention, trained on large-scale text corpora. The server configures the model with parameters such as a temperature value for controlling output variability and a maximum token length to constrain output size. The server executes the generative AI model on a hardware accelerator, such as a graphics processing unit, to generate response character information. The server thereby offloads the complex text generation operation to specialized hardware, improving processing speed and reducing main processor utilization.

The server receives the response character information produced by the generative AI model. The server applies post-processing rules to the generated text, such as constraining vocabulary, verifying that referenced times and locations appear in the underlying schedule data, and truncating or simplifying overly long or complex sentences. The server then transmits the validated response character information to the terminal. The terminal uses a text-to-speech program, which may be provided by a speech synthesis library or an external speech API, to convert the response character information into audio information. The terminal outputs the audio information through its speaker so that the user receives a natural spoken answer.

The terminal, during the dialog, also acquires audio information for acoustic analysis. The terminal segments the audio into fixed-length frames and computes low-level acoustic feature values for each frame using a feature extraction library, such as a library for computing Mel-frequency cepstral coefficients, pitch, formant frequencies, and energy values. In another embodiment, the terminal transmits raw or compressed audio information to the server, and the server performs the feature extraction. The server aggregates frame-level feature values into utterance-level and session-level vectors, such as averaging pitch over the utterance, computing the variance of speaking rate over a session, and calculating measures of tremor using jitter and shimmer.

The server stores the acoustic feature values in a structured manner. For each user, the server maintains a feature history in a time-series database or a set of indexed tables, where each entry contains a timestamp, a feature vector, and contextual information such as dialog type. The server uses these stored acoustic feature values to build a baseline profile for each user. In one implementation, the server computes statistical descriptors, such as mean and standard deviation of pitch, intensity, and speaking rate, over a reference period, such as several weeks. In another implementation, the server trains an autoencoder neural network for each user, where the autoencoder attempts to reconstruct typical feature vectors. The reconstruction error of the autoencoder then serves as a measure of deviation from the baseline profile. The server uses a disease risk analysis unit to compute an abnormality degree and disease risk information. The server provides recent acoustic feature sequences and baseline profile data as input to a supervised machine learning model, such as a recurrent neural network or a gradient boosting model. The machine learning model has been trained with labeled training data that includes examples of baseline and abnormal acoustic patterns corresponding to particular health conditions. During training, the server updates model parameters by minimizing a loss function, such as cross-entropy loss or mean squared error, using gradient descent or a similar optimization algorithm. The server may also apply regularization techniques and data augmentation, such as pitch perturbation and time-stretching, to improve model generalization. At runtime, the trained model outputs a risk score for each of several predefined health categories. The server converts the risk scores into an abnormality degree and disease risk information, which can include risk indices for specific conditions, risk levels, and explanations based on feature contributions.

The server uses the calculated disease risk information, together with attribute information, behavior information, and location information, to generate notification information data. The server applies deterministic rules and learned policies to determine which notification targets should be alerted, what kinds of recommended actions should be suggested, and what alert priority should be assigned. For example, the server may assign a higher priority if the abnormality degree exceeds a threshold or if the pattern of deviation matches profiles associated with rapid deterioration. The server encodes these elements into a structured representation, such as a tuple of (target class, recommended action, priority, timestamp, related risk indices).

The server then constructs another prompt sentence intended for the generative AI model to produce explanation character information for notifications. For example, the server generates a prompt sentence such as:

“Generate a concise alert message for care staff in a nursing home. Diagnosis: increased voice tremor and slower speaking rate over the last 3 weeks, possible early motor-related condition, severity: medium. Resident: elderly male, private room in east wing. Instructions: recommend scheduling a medical check, but avoid causing panic. Output one or two sentences.” The server sends this prompt sentence, along with the disease risk information, risk indices, baseline deviation measures, and alert parameters, to the generative AI model. The model produces explanation character information that describes the abnormal pattern and recommends appropriate actions in a human-readable form. The server verifies that the explanation character information is consistent with the underlying risk indices and baseline data. This integration of risk indices and baseline deviation measures into the prompt sentence allows the generative AI model to generate explanations that are aligned with the underlying computation and reduces the likelihood of inconsistent or fabricated content.

The server combines the explanation character information with the notification information data to generate notification messages for care service provider terminals and family terminals. The server formats these messages according to the capabilities of each terminal type. For example, for a care service provider terminal, the server may include detailed risk indices and a link to graphical plots of acoustic features over time. For a family terminal, the server may include a simplified explanation in plain language. The server uses communication protocols such as push notification services or electronic mail to transmit the notification messages through the communication network.

The server also manages consent information and enforces execution availability of acoustic feature storage and health state computation. The server maintains a consent record for each user, indicating whether the user or an associated person has granted permission for audio analysis and long-term storage of acoustic feature values. The server uses this record to determine whether to enable or disable certain processing modules. For example, if consent is withdrawn, the server instructs the terminal not to send further audio analysis data, halts the execution of disease risk computation for that user, and initiates deletion or anonymization operations on existing data records. Anonymization can be performed by removing personally identifying attributes or replacing them with pseudonymous identifiers. This consent management logic is implemented as a set of access control checks embedded in data ingestion and processing pipelines, ensuring that technical operations comply with current consent settings.

The system provides technical effects beyond mere automation of human tasks. The server uses computer-specific structures and algorithms to manage and analyze large volumes of time-series acoustic feature data that are difficult for humans to assess. The server reduces computational load by performing feature extraction at the terminal when possible, thereby transmitting lower-dimensional feature vectors instead of raw audio. The server improves disease risk detection accuracy and robustness by constructing user-specific baseline profiles, using neural network architectures such as autoencoders and recurrent networks trained with carefully designed loss functions and training schedules. The server enhances overall system performance by executing intensive generative AI and machine learning computations on dedicated accelerators, reducing response time and allowing real-time monitoring across many users.

The system also improves computer-based dialog and notification generation techniques. By encoding internal system states, such as risk indices and alert parameters, into prompt sentences for the generative AI model, the server creates a structured, machine-oriented protocol for leveraging generative AI. This protocol allows the generative AI model to generate explanation character information that is tightly coupled to underlying computations and data structures. This coupling provides consistent and predictable behavior that is not achievable with static, rule-based templates or unstructured text generation. The system uses the generative AI outputs not as arbitrary text, but as machine-consumable components that are validated and integrated with other structured data, thus improving both the accuracy and interpretability of notifications.

In another embodiment, the server uses different neural network architectures for disease risk analysis, such as a convolutional neural network applied to spectrogram representations of the audio information. In this case, the server converts audio information into time-frequency images using a short-time Fourier transform and then passes the resulting spectrograms through convolutional layers to extract patterns indicative of health-related changes. The server can also employ ensemble models that combine predictions from different model architectures to reduce variance and improve generalization.

In a further embodiment, the terminals execute part of the disease risk computation locally, such as computing preliminary risk scores based on simplified models, and send these scores to the server. The server then refines the risk assessment using more complex models and the full historical baseline. This distribution of computation reduces server load, lowers network bandwidth usage, and improves responsiveness. The system is therefore scalable to larger numbers of users without a linear increase in central processing resources.

In yet another embodiment, the server dynamically updates baseline profiles and risk model parameters using new labeled data. When care staff register follow-up outcomes, such as confirmed diagnoses or false alarms, the server associates these labels with previously computed feature sequences and risk indices. The server periodically retrains or fine-tunes the machine learning models using this labeled data, employing methods such as mini-batch stochastic gradient descent and validation on held-out data sets. The server thereby improves the mapping from acoustic feature deviations to disease risk, leading to lower false positive and false negative rates over time. This continual learning process represents a technical improvement in how the computing system adapts to evolving data distributions. Through these embodiments, the server, terminal, and user interact in a way that leverages specific data structures, algorithms, and hardware resources to provide a health monitoring and dialog system that is more precise, efficient, and adaptable than conventional systems. The system thus offers a concrete improvement in computer technology related to acoustic feature processing, machine learning-based risk evaluation, and structured generative AI integration using prompt sentences.

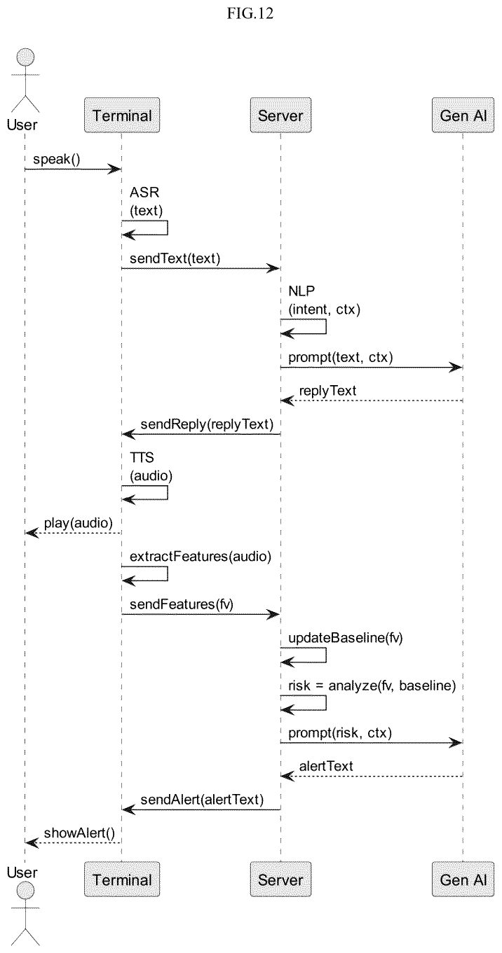

The following describes the processing flow using FIG. 12.

### Step 1:

User speaks to the terminal and initiates a dialog.

User provides spoken audio as input, for example by asking “What activities are there today?” or “How am I doing recently?”.

Terminal receives analog sound waves and converts them into digital audio information using its microphone, audio codec, and audio driver. Terminal outputs a stream of sampled audio frames (for example, 16 kHz, 16-bit PCM) as the result of this conversion.

### Step 2:

Terminal performs local audio preprocessing and speech recognition.

Terminal takes the raw audio frames as input and applies digital signal processing operations such as noise suppression, echo cancellation, and voice activity detection to remove background noise and segment speech regions. Terminal then applies a speech recognition engine to the cleaned audio frames, for example a neural network-based recognizer running locally or via an SDK, and outputs character information representing the recognized text together with metadata, including a timestamp, a session identifier, and a device identifier.

Terminal thereby transforms continuous audio signals into discrete textual data and associated identifiers.

### Step 3:

Terminal transmits recognized text and metadata to the server.

Terminal uses its communication interface to take the character information and metadata as input and encapsulates them into a structured message, for example a JSON object containing fields such as “session_id”, “user_id”, “recognized_text”, and “timestamp”. Terminal sends this message over a secure communication channel, such as HTTPS, to the server. Terminal outputs the message onto the network as the result of this transmission operation.

### Step 4:

Server receives dialog data and performs natural language processing.

Server accepts the structured message from the network as input and parses the message to extract the recognized text, the session identifier, and user-related identifiers. Server stores this information temporarily in a database record. Server then executes a natural language processing pipeline that tokenizes the text, assigns part-of-speech tags, identifies syntactic structure, and performs intent classification and entity extraction. Based on these operations, server outputs an intent label, such as “request_activity_schedule”, and a set of semantic entities, such as “today” or “afternoon”, along with the original text and user identifiers.

### Step 5:

Server retrieves user profile and contextual information.

Server takes the intent label, entities, and user identifiers as input and queries internal data repositories, such as a user profile table and a facility schedule table. Server applies selection conditions based on the entities and current date to retrieve relevant items, such as the list of activities scheduled for the current day and the user's preferences (for example, preference for group exercise or gardening). Server outputs a context package that includes user attribute information, facility schedule entries, and any relevant historical dialog context, combined into a structured data object for later processing.

### Step 6:

Server constructs a prompt sentence for the generative AI model for dialog response.

Server takes the recognized text, the intent label, the entities, and the context package as input and formats them into a single textual prompt sentence. Server includes explicit instructions, such as style, length, and tone, together with embedded schedule information. For example, server generates the following prompt sentence as output:

“You are an assistant in a care facility. An elderly resident asked: ‘What activities are there today?’. Use the following schedule data to generate a short, friendly spoken response that the resident can easily understand. Respond in one or two simple sentences.”

### Step 7:

Server invokes the generative AI model to generate a dialog response.

Server provides the prompt sentence as input to the generative AI model, which is implemented as a transformer-based neural network running on a processor or accelerator.

Server configures parameters such as temperature and maximum token count before sending the prompt sentence. Server receives generated character information from the generative AI model as output, for example: “Today we have light exercises in the morning, a gardening activity in the afternoon, and a movie session in the evening.”

### Step 8:

Server post-processes the generated dialog response.

Server takes the generated character information and the context package as input and validates the response content. Server checks that all mentioned activities and times are present in the schedule entries and that no unauthorized or inconsistent information appears. Server may truncate or simplify complex sentences and sanitize text according to predefined rules. Server outputs a validated response text that is aligned with actual schedule data and adapted to the user's profile.

### Step 9:

Server sends the dialog response to the terminal.

Server takes the validated response text and the session identifier as input and encapsulates them into a response message formatted for the terminal. Server transmits this message via the communication network to the terminal. Server outputs the response message as network data that the terminal can use to synthesize audio.

### Step 10:

Terminal converts response text to audio and outputs it to the user.

Terminal receives the response message from the network as input and extracts the response text. Terminal calls a text-to-speech engine, specifying the language, voice type, and speaking rate, and provides the response text as input to the engine. The text-to-speech engine processes the text and generates synthesized audio information as output. Terminal then sends the audio information to its audio driver, which drives the speaker to produce audible sound. User hears the spoken response as the final output of this step.

### Step 11:

Terminal captures audio for acoustic feature analysis.

Terminal uses the same audio stream captured during dialog as input for analysis. Terminal segments the audio into short time frames and applies feature extraction algorithms to each frame. Terminal calculates acoustic feature values, such as pitch, intensity, spectral centroid, jitter, shimmer, and estimated speaking rate. Terminal aggregates these values per utterance or per session, and outputs a set of feature vectors with associated timestamps and session identifiers.

### Step 12:

Terminal or server transmits acoustic feature data to the server's analysis module. Terminal uses its communication interface to take the feature vectors, timestamps, and identifiers as input and encapsulates them into a feature transmission message. Terminal encrypts the message if necessary and sends it to the server over the communication network. Alternatively, terminal may send raw audio segments, in which case server performs the feature extraction and outputs feature vectors internally. In either case, the result of this step at the server side is a set of stored acoustic feature vectors associated with specific users and times

### Step 13:

Server builds and updates a baseline profile of acoustic features.

Server takes newly received acoustic feature vectors and previously stored feature vectors as input and updates the baseline profile for each user. Server may compute running statistics, such as mean and standard deviation of pitch and speaking rate over a sliding time window, or may update parameters of an autoencoder or recurrent neural network that models typical acoustic patterns. Server outputs an updated baseline profile data structure that represents normal voice characteristics for each user at the current time.

### Step 14:

Server computes an abnormality degree and disease risk information.

Server provides the recent feature vectors, the baseline profile, and model parameters as input to a disease risk analysis model, such as a recurrent neural network or gradient boosting classifier. Server calculates the difference between current feature vectors and baseline values, and the model processes this difference along with absolute feature values to produce risk scores. Server interprets these risk scores to compute an abnormality degree for each monitored condition and aggregates them into disease risk information. Server outputs disease risk information that includes one or more risk indices, such as a numeric score between 0 and 1 for each condition, and classification labels, such as “low”, “medium”, or “high” risk.

### Step 15:

Server generates notification information data based on risk and context.

Server takes the disease risk information, the user's attribute information, behavior information, and location information as input and applies predefined rules or learned policies to determine notification parameters. For example, if a risk index exceeds a threshold or deviates from baseline rapidly, server decides to notify care staff with a high-priority alert. Server encodes the notification target category, recommended actions (such as “schedule medical check”), and alert priority, along with associated risk indices and timestamps, into a structured notification information object. Server outputs this notification information data for use in alert generation.

### Step 16:

Server constructs a prompt sentence for the generative AI model for alert explanation. Server uses the notification information data, disease risk information, and user context as input and formats them into an explanatory prompt sentence. For example, server generates: “Generate a concise alert message for care staff in a nursing home. Diagnosis: increased voice tremor and slower speaking rate over the last 3 weeks, possible early motor-related condition, severity: medium. Resident: elderly resident in a private room on the east wing. Instructions: recommend scheduling a medical check, but avoid causing panic. Output one or two sentences.”

Server outputs this prompt sentence as the input text for the generative AI model.

### Step 17:

Server invokes the generative AI model to produce explanation character information.

Server sends the constructed prompt sentence as input to the generative AI model, executing the model on appropriate computing hardware. The model processes the prompt sentence and, based on its learned parameters and the encoded instructions, generates explanation character information that describes the abnormal pattern and recommended actions. Server receives the explanation character information as output, for example: “The resident's recent voice data show increased tremor and slower speech compared with earlier records. Please consider arranging a medical check to evaluate possible early motor changes.”

### Step 18:

Server validates and formats alert explanation text.

Server uses the explanation character information and the underlying notification information data as input and checks for consistency and compliance with system rules. Server confirms that any referenced conditions or severities match the actual risk indices and that no contradictory advice is present. Server may adjust wording to fit message templates or limit length. Server outputs a finalized alert explanation text suitable for presentation to care staff and family members.

### Step 19:

Server generates and transmits notification messages to terminals.

Server takes the finalized alert explanation text, notification information data, and recipient identifiers as input and constructs notification messages in formats appropriate for different terminals, such as push notification payloads or emails. Server includes machine-readable fields, such as alert priority and resident location, and human-readable explanation text in each message. Server then transmits these messages over the communication network to care service provider terminals and family terminals. Server outputs transmitted notifications as network data that cause corresponding alerts on the terminals.

### Step 20:

Terminal displays and optionally vocalizes alert information to recipients.

Terminal receives a notification message from the network as input and extracts relevant fields, including explanation text, resident identifier, location, and recommended actions. Terminal renders this information on its display, for example showing the explanation text and alert priority. Terminal may also call a text-to-speech engine to convert the explanation text into audio information and play it through the speaker so that care staff hear the alert. Terminal outputs visual and/or audio alerts that guide recipients to respond appropriately.

### Step 21:

Server manages consent and controls analysis execution.

Server takes consent information updates from the user or an associated person as input, received via terminal interfaces or external systems. Server updates the stored consent status for the corresponding user and evaluates this status during all subsequent data processing operations. If consent is revoked, server disables feature storage and disease risk computation for that user and initiates deletion or anonymization of existing data records. Server outputs updated control flags and performs data modification operations that ensure only authorized processing is executed according to current consent settings.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional monitoring systems for elderly users typically rely on simple threshold-based sensors, emergency buttons, or basic speech logging. These systems generally collect raw audio or coarse speech features and may trigger alerts when static rules are met. However, such systems suffer from several technical limitations in the context of modern computer technology.

First, conventional systems do not efficiently integrate heterogeneous data streams, such as linguistic content and detailed acoustic characteristics, into a unified representation that can be processed by advanced machine learning models. Many existing implementations treat recognized text and audio features separately, or rely only on one of them, which leads to suboptimal use of computational resources and reduces the predictive power of machine-learning-based detection of subtle health anomalies. As a result, server-side machine learning modules often operate on fragmented, low-quality inputs, causing inaccurate emotion estimation and unreliable disease risk scoring.

Second, typical dialog systems and health monitoring platforms do not dynamically adapt generative AI behavior based on fine-grained emotional state and time-series health indicators. Generative AI models are usually called with static or ad-hoc prompts that do not systematically encode the user's current emotional state, longitudinal variations in speech features, or medically relevant risk scores. This leads to responses and notifications that are not consistently aligned with the user's psychological condition, and can even increase anxiety or fail to provide timely, context-appropriate guidance to external recipients such as medical service providers and family members.

Third, conventional architectures lack a standardized, machine-implementable mechanism for constructing structured prompt sentences that couple low-level signal-processing results, high-dimensional embeddings, and disease risk outputs into a single input for a generative AI model. Without a defined pipeline for generating response-oriented and notification-oriented prompt sentences from specific computed features and model outputs, systems cannot reliably leverage generative AI to produce technically constrained, target-specific texts (for example, non-diagnostic yet medically informative reports). This leads to inefficiencies in the use of computing resources and hinders automation of high-quality, consistent text generation. Fourth, known systems often perform health analysis using simplistic or non-temporal methods, without applying sophisticated machine learning models to time-series data of audio features and emotional states. This prevents the server from exploiting temporal patterns such as gradual changes in speaking rate, pitch, or tremor index correlated with persistent depressive or anxious emotional labels. As a result, early detection of disease-related anomalies is technically limited, and the server cannot compute robust, quantitative disease risk scores that drive automated notification logic.

Accordingly, there is a need for an improved computer-implemented system that: (i) systematically acquires and preprocesses audio signals into both text and rich audio feature vectors; (ii) integrates these heterogeneous features into multidimensional feature vectors for emotion classification; (iii) applies machine learning models to time-series emotion and audio features to obtain disease risk scores; and (iv) programmatically constructs and uses response-oriented and notification-oriented prompt sentences as inputs to a generative AI model. Such a system should technically improve the way servers and processors orchestrate data pipelines, model inference, and generative AI prompting, thereby enhancing accuracy, robustness, and appropriateness of dialog responses and health-related notifications.

The specific processing by the specific processing unit 290 of the data processing device 12 in Example 2 is realized by the following means.

The present invention provides a server comprising a processor and a memory storing instructions, wherein the processor is configured to execute the instructions to: acquire, from an audio input device located near a user, an audio signal representing spoken utterances of the user and perform sampling and frame division processing on the audio signal; perform speech recognition processing on the audio signal to generate character information that represents the utterance content as text data; perform frequency analysis and statistical analysis on the audio signal to extract audio feature values including at least a fundamental frequency, a sound volume, a speaking rate, a frequency spectrum, and a voice tremor index, and construct an audio feature vector as a numerical vector from the audio feature values; input the character information to a language representation model to generate a text embedding vector representing semantic features, and combine the text embedding vector and the audio feature vector into a multidimensional feature vector; input the multidimensional feature vector to an emotion classification model to estimate an emotional state of the user and store the estimated emotional state as time-series data; apply a machine learning model to time-series data of the audio feature values and the emotional state over a predetermined period to calculate statistical values and occurrence frequencies and to compute, based on the calculated statistical values and occurrence frequencies, at least one of a presence or absence of an abnormality in a health state of the user and a disease risk score of the user; generate a response-oriented prompt sentence as natural-language text by using the character information and the estimated emotional state, the response-oriented prompt sentence including response conditions for the user and being configured as input text for a generative AI model; generate a notification-oriented prompt sentence as natural-language text by using an abnormality determination result obtained from the disease risk score and the time-series data of the emotional state and audio feature values, the notification-oriented prompt sentence including notification conditions for an external recipient and including time-series statistical information, and being configured as input text for the generative AI model; cause the generative AI model to generate, based on at least one of the response-oriented prompt sentence and the notification-oriented prompt sentence, a response text for the user or a notification text for an external recipient; convert the response text into an audio signal by performing speech synthesis processing and output the audio signal to a sound output device; and transmit the notification text via a communication network to a terminal of a medical service provider or a terminal of a family member. This enables an integrated computer-implemented pipeline in which heterogeneous audio and text data are transformed into rich feature representations, emotion and health risk are estimated using machine learning over time-series data, and structured prompt sentences are programmatically constructed and supplied to a generative AI model so that dialog responses and health-related notifications are generated with improved technical accuracy, consistency, and context-appropriateness compared to conventional systems.

The term “system” refers to an arrangement of one or more computing devices and associated components that cooperate to execute the processing described herein, including acquisition, analysis, and generation of data.

The term “processor” refers to a hardware execution unit, such as a central processing unit or a graphics processing unit, or a set of such units, configured to execute instructions stored in a memory to perform data processing operations.

The term “memory” refers to a hardware storage medium, including volatile or non-volatile storage, configured to store instructions and data to be used by the processor.

The term “user” refers to a human individual whose speech is captured by the system and for whom emotion estimation, health state determination, and dialog responses are performed.

The term “audio input device” refers to a hardware device, such as a microphone or an array of microphones, configured to acquire acoustic signals produced by the user and convert the acoustic signals into electrical or digital audio signals.

The term “audio signal” refers to time-series data representing sound, including digitized waveform data obtained by sampling an analog acoustic signal at a specified sampling rate and bit depth.

The term “sampling processing” refers to a procedure in which an analog audio signal is converted into discrete digital samples at a predetermined sampling frequency and quantization resolution.

The term “frame division processing” refers to a procedure in which a time-series audio signal is divided into consecutive or overlapping short-time segments, referred to as frames, for subsequent analysis.

The term “speech recognition processing” refers to a computational process that analyzes an audio signal to identify linguistic content and to convert the audio signal into text data representing the spoken utterance.

The term “character information” refers to text data, encoded in a machine-readable format, representing the content of the user's utterance as determined by speech recognition processing.

The term “frequency analysis” refers to a computational operation that transforms a time-domain audio signal into a frequency-domain representation, such as a spectrum, using techniques including but not limited to Fourier transforms.

The term “statistical analysis” refers to processing that derives numeric measures, such as averages, variances, or higher-order statistics, from data including audio signals or extracted features.

The term “audio feature values” refers to numeric descriptors derived from an audio signal, including at least a fundamental frequency, a sound volume, a speaking rate, a frequency spectrum, and a voice tremor index.

The term “fundamental frequency” refers to a primary periodic component of a voiced audio signal, representing the perceived pitch of the user's voice and expressed as a frequency value.

The term “sound volume” refers to a quantitative measure of the amplitude or energy of an audio signal, representing loudness of the user's speech.

The term “speaking rate” refers to a measure of temporal speed of speech, such as the number of syllables, words, or voiced segments per unit time in the user's utterance.

The term “frequency spectrum” refers to a representation of the distribution of signal energy across frequency components of an audio signal.

The term “voice tremor index” refers to a numeric measure that quantifies fluctuations in voice characteristics, including pitch and amplitude variability, over time in the user's speech. The term “audio feature vector” refers to a numerical vector constructed from one or more audio feature values, formatted as a fixed-length or structured array suitable for input to a machine learning model.

The term “language representation model” refers to a statistical or machine-learning model configured to receive text as input and output one or more numerical representations that capture semantic and contextual properties of the input text.

The term “text embedding vector” refers to a numerical vector output by a language representation model, representing semantic and contextual features of the character information in a continuous vector space.

The term “multidimensional feature vector” refers to a numerical vector obtained by combining, such as by concatenation, at least a text embedding vector and an audio feature vector into a single feature representation.

The term “emotion classification model” refers to a trained machine learning model configured to receive a multidimensional feature vector as input and output a classification or probability distribution over emotional categories.

The term “emotional state” refers to data representing a psychological condition of the user, including at least an emotion label and optionally a corresponding confidence value or score. The term “time-series data” refers to data items collected or stored in association with temporal indices, such as timestamps or time steps, representing how values change over time.

The term “machine learning model” refers to a computational model with parameters learned from training data, configured to infer outputs such as predictions, classifications, or scores from input feature values.

The term “health state” refers to a condition of physical or mental well-being of the user, including the presence or absence of health abnormalities determined by machine learning or statistical analysis.

The term “abnormality” refers to a deviation in the health state of the user from a predetermined normal range, inferred based on audio feature values, emotional state, or derived statistics.

The term “disease risk score” refers to a numerical value computed by a machine learning model that quantitatively indicates a likelihood or risk level that the user has, or will develop, a particular health-related disorder or condition.

The term “response-oriented prompt sentence” refers to a natural-language text that is constructed as an input to a generative AI model and that includes at least character information, an emotional state, and response conditions for generating a dialog response for the user.

The term “notification-oriented prompt sentence” refers to a natural-language text that is constructed as an input to a generative AI model and that includes at least an abnormality determination result, time-series statistical information, and notification conditions for generating a notification text for an external recipient.

The term “response conditions” refers to constraints or directives described in natural language that specify desired properties of a generated response text, including tone, style, content scope, or level of detail.

The term “notification conditions” refers to constraints or directives described in natural language that specify desired properties of a generated notification text, including target recipient type, level of technical terminology, tone, and content limits such as non-diagnostic phrasing.

The term “generative AI model” refers to a machine-learning-based text generation model, such as a large-scale language model, configured to receive a prompt sentence as input and produce natural-language text as output.

The term “response text” refers to natural-language text generated by the generative AI model in response to a response-oriented prompt sentence and intended to be presented to the user in a dialog.

The term “notification text” refers to natural-language text generated by the generative AI model in response to a notification-oriented prompt sentence and intended to be delivered to an external recipient such as a medical service provider or a family member.

The term “speech synthesis processing” refers to a computational procedure that converts response text into an audio signal, for example by performing text-to-phoneme conversion and waveform generation using a synthesis algorithm.

The term “sound output device” refers to a hardware device, such as a loudspeaker or a headphone, configured to convert electrical or digital audio signals into audible sound for the user.

The term “communication network” refers to a wired or wireless data transmission infrastructure, including one or more networks such as local area networks, wide area networks, or public networks, used to exchange data between the server and external terminals.

The term “terminal of a medical service provider” refers to an information processing device operated by or on behalf of a medical professional or medical institution, configured to receive and display or process notification texts relating to the user.

The term “terminal of a family member” refers to an information processing device operated by a family member or caregiver of the user, configured to receive and display or present notification texts relating to the user.

The server, the terminal, and the user cooperate to implement the invention as follows.

The terminal is installed in an environment such as the home of an elderly user and functions as a front-end device. The terminal includes at least a processor such as a central processing unit, a memory, an audio input device such as a microphone, an audio output device such as a speaker, a network interface, and optionally an accelerator such as a graphics processing unit or a digital signal processor. The terminal runs an operating system such as an embedded operating system or a general-purpose desktop operating system. The terminal executes software modules including an audio acquisition module, a speech recognition client, an audio feature extraction module, a communication module, a text-to-speech module, and a prompt sentence construction module.

The server is implemented as one or more computing devices, for example, a cloud server cluster. The server includes a processor such as a multi-core central processing unit, optional accelerators such as one or more graphics processing units, a main memory, a secondary storage, and a network interface. The server runs a general-purpose operating system and executes an application stack including a web framework implementing a REST application programming interface, a natural language processing library, a machine learning library, a database management system, and connector modules for a generative AI model. The server stores one or more trained models including a language representation model, an emotion classification model, and a disease risk prediction model.

The user interacts naturally with the system by speaking in everyday language towards the terminal. The user does not need to operate buttons or graphical user interfaces. The user is, for instance, an elderly person living alone who utters questions such as “I have not been sleeping well recently. What news is there today?” or remarks such as “I do not feel like doing anything these days.”

The terminal physically acquires the user's speech through the microphone. The terminal converts the analog acoustic pressure into an electrical signal and then into a digital audio signal through an analog-to-digital converter at a sampling rate such as 16 kHz and a bit depth such as 16 bits. The terminal stores the digitized waveform as pulse-code-modulated data in the memory. The terminal executes a level detection routine on the processor that continuously computes short-time energy or root-mean-square amplitude on sliding windows. The terminal compares these values with a predefined threshold and determines when the audio level crosses from a silent state to an active state and back. This enables the terminal to precisely bound an utterance interval and discard irrelevant background noise segments, which reduces unnecessary communication load to the server and improves subsequent model accuracy by filtering non-speech segments.

The terminal then performs or invokes speech recognition processing. In one embodiment, the terminal sends the PCM data to an external speech recognition service via the network interface, using a client library suitable for a generic cloud speech-to-text service. The terminal packages the audio data in a defined format, sets recognition parameters such as language code, and transmits it through a secure protocol. The speech recognition service returns a structured response that includes a list of candidate transcriptions and associated confidence scores. The terminal parses this response and selects the candidate with the highest confidence. The terminal stores the selected transcription as character information in the memory.

The terminal also executes an audio feature extraction module implemented using a general audio processing library such as a library for Python audio analysis or a library for digital signal processing. The terminal divides the PCM data into short frames, for example, 25 milliseconds in length with an overlap of 10 milliseconds. The terminal applies a window function such as a Hamming window to each frame and computes a short-time Fourier transform to obtain a frame-level amplitude spectrum. The terminal then applies a Mel filterbank to map spectral energy to Mel frequency bands and performs a discrete cosine transform to compute Mel-frequency cepstral coefficients. These Mel-frequency cepstral coefficients represent the spectral envelope in a compact form and form part of the audio feature values.

The terminal, for pitch estimation, applies an algorithm such as an autocorrelation-based pitch detector or a YIN-based method to each voiced frame, computing a fundamental frequency value per frame. The terminal computes frame-level energy as the sum of squared sample amplitudes to obtain a measure of sound volume. The terminal estimates speaking rate by counting the number of voiced frames or syllable-like peaks in the energy or pitch contour and dividing by the utterance duration. The terminal calculates a voice tremor index by computing variability metrics such as standard deviation, jitter, or shimmer over the pitch sequence or amplitude sequence. These operations produce a structured set of audio feature values that capture physical and temporal properties of the user's speech beyond simple amplitude thresholds.

The terminal constructs an audio feature vector by arranging the audio feature values into a structured numerical array. In one embodiment, the terminal computes per-utterance statistics such as mean, variance, and higher-order moments of each per-frame feature (for example, mean fundamental frequency, variance of fundamental frequency, mean of Mel-frequency cepstral coefficients, variance of Mel-frequency cepstral coefficients, mean speaking rate, mean voice tremor index). The terminal combines these statistics into a fixed-length vector. The terminal also stores metadata such as user identifier and timestamps.

The terminal constructs a message object, for example as a JavaScript object notation structure, that encapsulates the character information, the audio feature vector, and the metadata. The terminal sends this structured data to the server via the network interface using hypertext transfer protocol over a transport protocol. The communication module implements retries, timeout management, and encryption, which reduces packet loss and ensures that the server receives synchronized text and feature data for each utterance. This specific data packaging and synchronous transmission provide a technical improvement in data integrity and alignment for multi-modal model inference.

The server receives the request at a web application endpoint implemented using a general web framework. The server parses the incoming JSON payload and reconstructs internal data structures linking the character information, the audio feature vector, and the associated metadata. The server stores this data in a buffer in main memory and may also insert a record into a relational database or a key-value store for long-term storage. This database indexing by user identifier and timestamp enables efficient retrieval of time-series data for later health analysis.

The server processes the character information using a language representation model implemented as a transformer-based neural network, such as a multi-layer encoder architecture trained on a large corpus of text. The server first tokenizes the text using a subword tokenizer, generating a sequence of discrete token identifiers. The server maps each token identifier to an embedding vector and adds positional encodings. The server then applies multiple layers of self-attention and feed-forward networks, each layer computing weighted combinations of previous layer outputs and applying nonlinear activation functions. The server obtains a final hidden representation, for example a pooled vector corresponding to a special classification token, and designates this representation as a text embedding vector. This vector numerically encodes semantics and context of the utterance.

The server simultaneously preprocesses the audio feature vector using a machine learning preprocessing module. The server loads pre-computed normalization parameters, such as means and standard deviations derived from training data. The server subtracts the mean and divides by the standard deviation for each feature dimension, resulting in a normalized audio feature vector. The server optionally applies dimensionality reduction or projection, such as a linear transformation or principal component projection, to match the input dimensionality expected by downstream models. This normalization improves model convergence and stability, leading to improved classification accuracy and reduced numerical error. The server then combines the text embedding vector and the normalized audio feature vector. In one embodiment, the server concatenates these vectors along the feature dimension to construct a multidimensional feature vector. In another embodiment, the server applies a learned linear transformation to each vector and then computes an element-wise sum or concatenation. The unified multi-modal representation allows the server to exploit correlations between linguistic content and acoustic patterns, which is a technical improvement over systems that process each modality separately.

The server inputs the multidimensional feature vector to an emotion classification model. In one embodiment, the emotion classification model is implemented as a feed-forward neural network with multiple hidden layers. Each layer performs a matrix multiplication of the input vector by a learned weight matrix, adds a bias vector, and applies a nonlinear activation function such as rectified linear unit. The final layer outputs a logit vector corresponding to several emotion classes including joy, anger, sadness, anxiety, depression, and calm. The server applies a softmax function to convert logits into a probability distribution. The server selects the emotion class with the maximum probability as the emotion label and designates this class and its probability as the emotional state for the current utterance. The server commits the emotional state to the database along with the associated time and user identifier, thereby forming part of the time-series data.

The server computes a health state based on time-series data. The server periodically retrieves, from the database, sequences of audio feature vectors and emotional states for a predetermined time window, such as the previous 30 days. The server aggregates these sequences into a time-series matrix where each row corresponds to a day or a session and each column corresponds to a feature such as daily mean speaking rate, daily mean fundamental frequency, daily voice tremor index, and daily frequency of each emotion label. The server may smooth these series using moving averages. The server then applies a machine learning model such as a gradient boosting decision tree or a recurrent neural network.

In one embodiment, the server uses a gradient boosting decision tree model configured to operate on fixed-length feature vectors. The server flattens or summarizes the time-series statistics into a single feature vector per user, including measures such as slope of speaking rate over time and variance of depressive label frequency. The server passes this vector to a gradient boosting decision tree model, which is trained with a specified loss function such as logistic loss. The model computes decision paths across multiple shallow trees and outputs a disease risk score representing the probability of an abnormal health condition. The server compares this score with a threshold value, which may be determined from validation data. If the score exceeds the threshold, the server flags the presence of an abnormality. In another embodiment, the server employs a recurrent neural network such as a long short-term memory network. The server feeds the sequence of daily feature vectors into the recurrent network. At each time step, the network updates its hidden state based on the current input and previous hidden state through gates that implement learned weight matrices and nonlinear functions. After processing the entire sequence, the network outputs a scalar or vector representing the disease risk score. The server evaluates this score with respect to a predetermined threshold. The use of recurrent networks allows the server to capture temporal dependencies and gradual trends in speech and emotion patterns, which yields improved risk prediction compared to static threshold-based rules.

The server constructs structured prompt sentences for a generative AI model. The server stores logic that synthesizes response-oriented prompt sentences by combining the most recent character information, the estimated emotional state, and a set of response conditions. For example, when the user utters “I have not been sleeping well lately. What news is there today?” and the emotional state is classified as slightly depressive, the server or the terminal constructs the following prompt sentence:

User utterance: “I have not been sleeping well lately. What news is there today?”

User's emotional state: slightly depressive (score 0.60)

Conditions:
Please answer in a gentle and calm tone that reassures an elderly person.
Please be careful not to unnecessarily increase anxiety about sleep.
Please summarize 2-3 news items for today in easy Japanese.

Please create a Japanese response that satisfies the above conditions.

The server also constructs notification-oriented prompt sentences when the disease risk score exceeds the threshold. For example, the server constructs a prompt sentence for a medical service provider as follows:
Based on the following voice-analysis results and emotional trends for an elderly person, please draft a report for a physician in Japanese.

Conditions:
Use appropriate medical terminology and summarize concisely in about one A4 page.
Do not perform a diagnosis; limit the wording to “it is recommended that the patient visit a doctor because depression may be present.”

Data:
Over the past 30 days, there has been a consistent decrease in speaking rate and an increase in the voice tremor index.
In the same period, the “depressive” label has appeared in 65% of all utterances.
The user has repeatedly uttered phrases such as “I do not feel motivated recently” and “Nothing feels enjoyable.”

Please create a draft report that helps the physician easily understand the situation.

The server constructs a prompt sentence for a family member as follows:

Based on the following information, please create a message in Japanese that gently explains the recent condition of an elderly family member.

Conditions:
Do not cause unnecessary anxiety; keep the tone as “please check in and talk to them.” Information:
Recent conversations suggest ongoing low energy and a somewhat depressed mood.
Changes are also observed in voice tone and speaking style compared with before.
The system recommends, as a precaution, that you talk to them about how they feel and, if necessary, consult a physician.

Please create a family-oriented message of about 300 Japanese characters based on this information.

The server, in each case, programmatically assembles the textual content of these prompt sentences using templates and variable insertion based on computed values and model outputs. The processor on the server executes string concatenation and formatting operations but also enforces constraints such as maximum length, inclusion of specific disclaimers, and anonymization rules. This structured prompt generation ensures that the input to the generative AI model is not arbitrary text but a defined data structure encoded as natural language, which constitutes a technical mechanism for controlling model behavior and output type.

The server sends the response-oriented or notification-oriented prompt sentence to the generative AI model through an application programming interface. In one embodiment, the generative AI model is hosted on a separate server infrastructure and implemented as a large-scale transformer-based language model. The server transmits the prompt sentence along with control parameters such as temperature, top-k value, and maximum token count. The generative AI model tokenizes the prompt, processes it through multiple layers of self-attention and feed-forward networks, and produces a sequence of output tokens representing the response text or notification text. The use of structured prompt sentences that encode specific technical conditions-such as non-diagnostic wording, target tone, and content boundaries-improves the reliability and predictability of the generative output, which is a technical improvement over unstructured, ad-hoc prompting.

The terminal receives the generated response text from the generative AI model through the server and passes it to a text-to-speech engine. The text-to-speech engine may be a neural network-based model that converts text to acoustic features and then to waveform through a neural vocoder. The terminal configures the speaking rate, pitch, and volume of the synthesized speech based on user preferences and the estimated emotional state. For example, when the emotional state is anxious, the terminal may reduce the speaking rate and maintain a stable pitch to produce a calmer voice. The terminal sends the synthesized waveform to the speaker, thereby providing an auditory output that is technically tailored to the user's condition.

The server delivers notification texts to external terminals. For example, when the disease risk score indicates a high probability of depression, the server sends the physician-oriented notification text via email or secure messaging to a terminal operated by a medical service provider. The server formats the notification according to communication protocol requirements and includes metadata such as timestamps and reference identifiers. The server also sends family-oriented notifications to a terminal operated by a family member. These terminals can display the text on a screen or convert it to speech using local text-to-speech engines.

This configuration provides multiple technical effects. The integration of text embeddings and audio feature vectors into a multi-modal representation yields higher emotion classification accuracy than using either modality alone. The machine learning models operating on time-series features detect gradual changes that human observers or simple rules might overlook, thereby enabling earlier and more reliable detection of health anomalies. The structured generation of prompt sentences ensures that the generative AI model operates under explicit constraints, which improves the consistency, safety, and relevance of generated texts. The automated orchestration of these components reduces communication bandwidth by sending processed feature vectors instead of raw audio, reduces computation at the terminal by offloading heavy inference to the server, and improves system-wide latency by optimizing pre-processing and model invocation order.

The system improves computer technology itself by introducing a non-conventional data pipeline that tightly couples signal processing, multi-modal embedding, time-series machine learning, and generative prompting. The server and the terminal execute specialized algorithms that are not merely automation of human mental processes. For example, the recurrent neural network that estimates disease risk optimizes a loss function such as cross-entropy over many training examples, updating millions of parameters via stochastic gradient descent with back-propagation through time. This training process constructs internal representations of temporal patterns that no human could manually derive with comparable consistency or scale. The emotion classification model and the disease risk model operate on high-dimensional feature spaces that are specifically engineered to exploit computational resources such as vectorized instructions and parallel processing on graphics processing units. The system employs specific data structures and rules distinct from human decision trees. The multi-modal feature vector encodes low-level audio statistics and high-level semantic embeddings in a fixed, machine-optimized format. The server enforces deterministic prompt construction rules that map numerical features and labels to text segments, ensuring that the generative AI model receives inputs that reflect quantitative states of the system rather than arbitrary prose. These rules and structures produce reproducible outputs and significantly reduce variance of generated messages compared to ad-hoc human prompting, which improves reliability and safety in operational deployments.

In alternative embodiments, the terminal performs more processing locally. For example, the terminal may host a lightweight emotion classification model and send only the emotional state and coarse audio features to the server, thereby reducing network load at the cost of some classification accuracy. In another variation, the terminal performs speech recognition entirely locally using an on-device neural network. The server still executes the language representation model, the disease risk model, and prompt construction, demonstrating that the invention is flexible with respect to the allocation of computational tasks between the terminal and the server.

In another embodiment, the server and terminal handle multiple users and multiple terminals. The server indexes time-series records by user identifiers and manages model inference for many users concurrently. The same architecture can be applied in other domains where voice and emotional state monitoring is critical, such as remote rehabilitation, long-term mental health support, or driver monitoring systems. In each case, the combination of multi-modal feature extraction, time-series machine learning, and structured prompt generation for a generative AI model provides a technical framework for improving the accuracy, efficiency, and safety of computing systems that interact with humans via speech.

In summary, the server and the terminal realize the invention by implementing concrete signal processing algorithms, machine-learning architectures, defined data structures, and deterministic prompt construction procedures that collectively enhance the technical performance of emotion-aware and health-aware conversational systems.

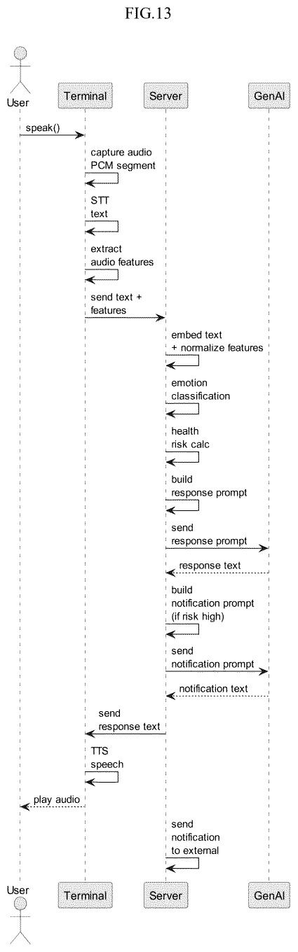

The following describes the processing flow using FIG. 13.

### Step 1:

The user provides a spoken utterance as input by talking naturally toward the terminal, for example, “I have not been sleeping well lately. What news is there today?”

The terminal receives the acoustic waveform as input through a microphone and converts the analog signal into a 16 kHz, 16-bit PCM digital audio signal. The terminal performs data processing by sampling, quantizing, and storing the resulting PCM samples in memory as a contiguous audio buffer. The terminal continuously computes short-time energy over sliding windows, compares the energy to a threshold, and detects the start and end of active speech segments. The terminal outputs a bounded PCM segment corresponding to a single utterance, together with timestamps indicating the detected start and end times.

### Step 2:

The terminal takes the bounded PCM segment as input and prepares it for speech recognition. The terminal performs data processing by encoding or packaging the PCM data into the format expected by a speech-to-text engine (for example, raw linear PCM with a header). The terminal sends this formatted audio as input to a speech recognition service via a client library and an HTTP request. The speech recognition engine analyzes the audio and returns a JSON structure containing candidate transcriptions and confidence scores. The terminal parses the JSON, selects the candidate with the highest confidence, and outputs character information as a text string representing the user's utterance, along with the associated confidence value.

### Step 3:

The terminal receives the same bounded PCM segment as input for audio feature extraction. The terminal performs data processing by dividing the PCM sequence into overlapping frames (for example, 25 ms length, 10 ms shift), applying a window function to each frame, and computing a short-time Fourier transform to obtain a magnitude spectrum per frame. The terminal applies a Mel filterbank and a discrete cosine transform to calculate Mel-frequency cepstral coefficients for each frame. The terminal further computes frame-level pitch using an autocorrelation- or YIN-based algorithm, frame energy for loudness, global speaking rate by counting voiced frames over utterance duration, and a voice tremor index by calculating variability statistics of pitch and amplitude over time. The terminal aggregates these per-frame features into per-utterance statistics such as means and variances, and outputs an audio feature vector as a structured numerical array representing MFCC statistics, mean pitch, pitch variance, mean loudness, speaking rate, and tremor index.

### Step 4:

The terminal uses the character information, the audio feature vector, and metadata as input to construct a transmission message. The terminal performs data processing by creating a structured object (for example, with fields for user identifier, utterance start time, utterance end time, text string, and numeric feature values) and serializing the object into JSON format. The terminal passes the JSON as input to the communication module, which attaches protocol headers and authentication data, and sends the message using HTTPS to an API endpoint of the server. The terminal outputs a network request that encapsulates all data needed for server-side analysis.

### Step 5:

The server receives the HTTPS request containing the JSON payload as input. The server performs data processing by parsing the JSON to extract the user identifier, timestamps, character information, and raw audio feature values. The server stores these values in an in-memory structure and optionally in a database. The server outputs decoded data comprising the text string, a preliminary audio feature vector, and associated metadata, ready for further machine-learning processing.

### Step 6:

The server takes the character information as input to the natural language processing pipeline. The server performs data processing by applying tokenization to split the text into tokens, mapping tokens to integer IDs, and feeding the token IDs into a transformer-based language representation model. Inside this model, the server executes matrix multiplications, attention computations, and non-linear activations across multiple layers to produce contextual hidden states. The server derives a pooled vector (for example, corresponding to a special classification token) as a text embedding vector. Concurrently, the server takes the raw audio feature values as input to a normalization routine, subtracts pre-computed means, divides by pre-computed standard deviations per feature dimension, and optionally applies a linear projection. The server outputs a normalized audio feature vector and a text embedding vector that are dimensionally compatible with an emotion classification model.

### Step 7:

The server receives the text embedding vector and the normalized audio feature vector as input to the multi-modal fusion process. The server performs data processing by concatenating the two vectors along the feature dimension, forming a multidimensional feature vector. The server then inputs this multidimensional feature vector into an emotion classification neural network. Within the network, the server executes a sequence of linear transformations (matrix multiplications plus bias additions) and non-linear activation functions, followed by a softmax operation at the output layer. The server computes a probability distribution over emotion classes and selects the class with the highest probability as the emotion label. The server outputs an emotional state record including the emotion label and the corresponding probability score, associated with the user identifier and timestamp.

### Step 8:

The server takes the new emotional state and existing time-series records of emotional states and audio feature vectors as input for health state analysis. The server performs data processing by querying the database for data within a predetermined period (for example, 30 days), grouping them by day or session, and computing daily statistics such as average speaking rate, average pitch, average tremor index, and frequency of depressive or anxious labels. The server constructs a time-series feature matrix and either flattens it into a fixed-length vector or feeds it sequentially into a recurrent neural network, depending on the selected disease risk model. The server computes a disease risk score as output through forward propagation in the model and compares this score to a threshold. The server outputs a health state determination result that includes the disease risk score and an abnormality flag indicating whether the score exceeds the threshold.

### Step 9:

The server uses the character information and the emotional state as input to construct a response-oriented prompt sentence. The server performs data processing by selecting response conditions based on the emotion label (for example, encouraging tone for “depressive,” calming tone for “anxious”) and formatting these conditions together with the user's text into a single natural-language instruction. For the input utterance “I have not been sleeping well lately. What news is there today?” and an emotional state of slightly depressive (score 0.60), the server constructs the following prompt sentence as output:

User utterance: “I have not been sleeping well lately. What news is there today?” User's emotional state: slightly depressive (score 0.60)

Conditions:
Please answer in a gentle and calm tone that reassures an elderly person.
Please be careful not to unnecessarily increase anxiety about sleep.
Please summarize 2-3 news items for today in easy Japanese.

Please create a Japanese response that satisfies the above conditions.

### Step 10:

The server uses the health state determination result, the time-series feature statistics, and representative emotional state trends as input to construct a notification-oriented prompt sentence when an abnormality is detected. The server performs data processing by inserting calculated values, such as the percentage of depressive labels and trends in speaking rate and tremor index, into predefined text templates. The server also adds notification conditions describing target recipients and content limitations (for example, “do not perform a diagnosis”). When the disease risk score for depression exceeds the threshold, the server outputs a prompt sentence such as:

Based on the following voice-analysis results and emotional trends for an elderly person, please draft a report for a physician in Japanese.

Conditions:
Use appropriate medical terminology and summarize concisely in about one A4 page.
Do not perform a diagnosis; limit the wording to “it is recommended that the patient visit a doctor because depression may be present.” Data:
Over the past 30 days, there has been a consistent decrease in speaking rate and an increase in the voice tremor index.
In the same period, the “depressive” label has appeared in 65% of all utterances.
The user has repeatedly uttered phrases such as “I do not feel motivated recently” and “Nothing feels enjoyable.”

Please create a draft report that helps the physician easily understand the situation.

### Step 11:

The server takes either a response-oriented prompt sentence or a notification-oriented prompt sentence as input to a generative AI model interface. The server performs data processing by embedding the prompt sentence into an API request payload, attaching model selection parameters and generation parameters such as temperature and maximum token count, and sending the request to the generative AI model endpoint. The generative AI model processes the prompt and returns a generated text sequence. The server receives the API response, parses the payload, and extracts the generated response text (for the user) or notification text (for an external recipient). The server outputs the generated text along with identifiers linking it to the corresponding user and context.

### Step 12:

The terminal receives the generated response text from the server as input for speech output. The terminal performs data processing by passing the text to a text-to-speech engine, which converts the text into intermediate linguistic units and then into a synthesized waveform using an acoustic model and a vocoder. The terminal adjusts playback parameters such as volume and speaking rate according to user settings and, optionally, the emotional state. The terminal outputs the synthesized waveform to the speaker, producing an audible response that the user hears.

### Step 13:

The server receives the generated notification text for a medical service provider or a family member as input to a notification delivery module. The server performs data processing by selecting a communication channel (for example, email, secure messaging, or push notification), formatting the notification text into the required message structure, and attaching recipient addresses or device tokens. The server sends the message through the appropriate network service and outputs a delivery status record indicating success or failure, which can be logged and associated with the user's health event.

### Step 14:

The server and the terminal together use the updated emotion records, health state determinations, and log data as input to ongoing operation and optimization. The server performs data processing by periodically retraining or fine-tuning the emotion classification model and the disease risk model using accumulated, anonymized feature vectors and labels.

The server updates model parameters through gradient-based optimization to reduce validation loss, and then deploys the updated models for subsequent inferences. The server outputs improved model versions that yield more accurate emotional state estimation and disease risk scoring, which in turn enhance the quality of prompt sentences and generated texts in future interactions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems that interact with elderly users typically separate conversational functionality from health-related monitoring functions. In many implementations, a dialogue engine generates responses solely from recognized text, while a separate analytic component, if present at all, inspects limited acoustic indicators in an offline manner. As a result, such systems often fail to (i) integrate multi-modal information (acoustic features and linguistic content) in real time, (ii) estimate a user's emotional state with sufficient robustness, (iii) correlate emotional state and acoustic features with health-related abnormalities using machine learning, and (iv) adapt the style and content of dialogue responses and notifications dynamically according to these inferred states.

Furthermore, in existing architectures, generative artificial intelligence models, such as large language models, are usually invoked with generic or manually crafted prompts that do not systematically encode structured information about user intent, emotion, and health-state assessments. This leads to several technical drawbacks: the generative models may output responses whose tone is misaligned with the user's emotional condition; the models may omit important contextual constraints, such as facility policies or user preferences; and the models may produce verbose or irrelevant content that increases processing overhead and reduces system reliability. Because the prompt construction is not automated from machine-interpretable state variables, the behavior of the generative model is difficult to control, to verify, and to optimize in a repeatable way.

In addition, many monitoring systems that rely on machine learning for health-state detection process only short-term data segments and do not incorporate long-term temporal changes in acoustic features and emotion scores. Such systems are unable to detect gradual deterioration, such as slowly increasing depression risk or cognitive decline, and they cannot generate notifications that synthesize both short-term anomalies and long-term risk trends in a coherent and structured manner. When notifications are generated, they are often template-based and rigid, lacking customization of tone and detail level for different recipients such as care workers and family members.

From a computer-technology perspective, there is a need for an improved architecture in which a processor systematically (i) acquires and fuses acoustic and textual data, (ii) performs intent estimation, emotion estimation, and health-state determination by coordinated machine-learning processing, (iii) automatically constructs machine-readable and human-interpretable prompt sentences that encode these states for a generative AI model, and (iv) uses the generative AI model under such structured control to generate both dialogue responses and notification messages whose tone and content are dynamically adapted. Without such integration, it is difficult to achieve stable, context-aware generative behavior, to reduce manual prompt engineering, and to improve the overall technical performance of the dialogue and monitoring system, including accuracy of anomaly detection, controllability of generated content, and efficiency of system operation.

The specific processing by the specific processing unit 290 of the data processing device 12 in Application Example 2 is realized by the following means.

The present invention provides a server comprising a processor configured to perform dialogue control processing that generates a natural language dialogue response on the basis of utterance information of a user; to acquire acoustic information of the user by performing voice information acquisition processing on the utterance information of the user; to calculate acoustic feature information by performing acoustic feature calculation processing on the acoustic information; to generate character information by performing speech recognition processing on the acoustic information; to estimate an utterance intention of the user by performing natural language processing on the character information; to estimate an emotional state of the user on the basis of at least one of the acoustic feature information and the character information by using emotion estimation processing; to determine presence or degree of an abnormality in a health state of the user by executing a machine learning model that receives as input at least one of the acoustic feature information and the emotional state; to generate a prompt sentence to be input to a generative AI model by performing prompt generation processing based on the utterance intention, the emotional state, a health state determination result obtained by the machine learning model, and at least part of attribute information of the user or environment information; to input the prompt sentence to the generative AI model to cause the generative AI model to generate a dialogue response sentence, and to present the dialogue response sentence to the user by performing response generation processing; and to generate notification information including at least abnormality content, an assumed risk, and a recommended action, and to transmit the notification information to an external information processing apparatus when the abnormality in the health state of the user is detected, by performing notification generation processing. This enables the server to technically improve multi-modal analysis and generative behavior by automatically transforming low-level acoustic and textual signals into structured internal state variables and into controlled prompt sentences for the generative AI model, thereby increasing accuracy of health-state anomaly detection, enhancing alignment of generated dialogue tone and content with the user's emotional condition and health status, and providing flexible, recipient-specific notification messages in an efficient and scalable manner.

The term “dialogue control processing” refers to processing by which the processor manages a dialogue flow and generates natural language responses based on input utterance information from a user, including selecting or generating response content and timing according to internal state and context.

The term “utterance information” refers to information representing spoken input from a user, including at least audio signals captured by an input device and, in some cases, associated metadata such as timestamps or segment boundaries.

The term “voice information acquisition processing” refers to processing by which the processor obtains acoustic information from the utterance information, for example by capturing audio data via an audio interface and segmenting the audio data into utterances. The term “acoustic information” refers to digital data representing audio signals of the user's speech, including sampled waveform data or encoded audio data suitable for further signal processing.

The term “acoustic feature calculation processing” refers to processing by which the processor analyzes acoustic information to compute numerical descriptors of the speech signal, such as fundamental frequency, energy, spectral characteristics, speech rate, and pause duration.

The term “acoustic feature information” refers to numerical data obtained from the acoustic feature calculation processing, including individual frame-level features and aggregated statistics that characterize properties of the user's speech.

The term “speech recognition processing” refers to processing by which the processor converts acoustic information into character information using pattern recognition and language modeling techniques, including feature extraction, acoustic modeling, and decoding.

The term “character information” refers to digital data representing textual content obtained from the user's speech, including sequences of characters, symbols, or tokens corresponding to recognized words or utterances.

The term “natural language processing” refers to processing by which the processor analyzes character information using linguistic techniques such as tokenization, morphological analysis, syntactic analysis, semantic analysis, and text classification.

The term “utterance intention” refers to information indicating a communicative purpose or function of a user's utterance, such as a question, request, small talk, or health consultation, as inferred from character information and context.

The term “emotion estimation processing” refers to processing by which the processor infers an emotional state of the user from at least one of acoustic feature information and character information using statistical models or machine learning models.

The term “emotional state” refers to information representing a psychological or affective condition of the user, including at least one category such as joy, anxiety, depression, anger, or neutral, and optionally an associated intensity or probability.

The term “machine learning model” refers to a computational model whose parameters are determined by a learning process using training data, and which outputs at least one classification result, score, or probability based on input features.

The term “health state” refers to a condition related to physical or mental health of the user, including, for example, levels of risk for depression, neurodegenerative disorders, or cognitive decline.

The term “health state determination result” refers to an output of the machine learning model indicating presence or degree of an abnormality in the health state of the user, expressed as at least one label, score, or probability.

The term “prompt generation processing” refers to processing by which the processor constructs a prompt sentence for a generative AI model using internal state variables such as utterance intention, emotional state, health state determination result, and contextual information.

The term “prompt sentence” refers to a text string provided as input to a generative AI model, the text string describing instructions, constraints, and contextual information for controlling content, style, and tone of a generated output.

The term “generative AI model” refers to a model based on artificial intelligence techniques, such as a neural network language model, that generates natural language output in response to an input prompt sentence and optional context information.

The term “dialogue response sentence” refers to natural language text generated by the generative AI model in response to a prompt sentence, the text being intended for presentation to the user as part of a dialogue.

The term “response generation processing” refers to processing by which the processor obtains a dialogue response sentence from the generative AI model using a prompt sentence, optionally post-processes the dialogue response sentence, and causes the dialogue response sentence to be presented to the user.

The term “attribute information of the user” refers to information describing characteristics of the user, including at least one of age group, preference, past interaction history, or health-related profile.

The term “environment information” refers to information describing context in which the user interacts with the system, including at least one of location, time, facility schedule, or device configuration.

The term “notification generation processing” refers to processing by which the processor generates notification information that describes abnormality content, assumed risk, and recommended action based on a health state determination result and optionally other context. The term “notification information” refers to information generated for external recipients, including at least a summary of an abnormality in the health state of the user, a description of possible risks, and one or more recommended actions.

The term “external information processing apparatus” refers to a device outside the system, such as a terminal used by a care worker, a terminal used by a family member, or another server, which is configured to receive and display or further process notification information.

In one embodiment, the system includes at least one terminal operated by a user and at least one server connected to the terminal via a communication network. The terminal includes a microphone, a speaker, a processor, a memory, and a communication interface. The server includes a processor, a memory, a network interface, and an electronic storage unit such as a database system.

The terminal executes an operating system such as a mobile operating system, a desktop operating system, or an embedded operating system. The terminal uses an audio input interface provided by the operating system, such as a generic audio capture API, to obtain digital audio data from the microphone. The terminal converts analog speech of the user into digital acoustic information, for example 16-bit linear PCM sampled at approximately 16 kHz, and stores the acoustic information in a buffer in the memory.

The terminal executes a speech recognition library on the processor. The terminal may use an open-source speech recognition engine such as a recurrent-neural-network-based engine, a time-delay neural network based engine, or a similar engine. The terminal applies a window function to the buffered acoustic information, performs frame splitting, and executes a Fast Fourier Transform to obtain a short-time spectrum for each frame. The terminal applies a mel filterbank to transform the spectrum into mel-scale energies and then computes mel-frequency cepstral coefficients. The terminal normalizes these coefficients and passes the sequence of coefficients to an acoustic model implemented as a neural network. The terminal executes a decoding algorithm that combines posterior probabilities output from the acoustic model with a language model, and converts the sequence of probabilities into character information representing recognized words or characters of the user's utterance.

The terminal executes a digital signal processing library such as a general-purpose audio analysis library or a phonetic analysis library on the processor to calculate acoustic feature information. The terminal computes fundamental frequency trajectories, short-time energy, spectral centroid, spectral bandwidth, mel-frequency cepstral coefficients, and silence durations. The terminal calculates summary statistics including mean, variance, minimum, and maximum values over an utterance segment, and the terminal derives secondary metrics such as speech rate and pause ratios. The terminal organizes these values as an acoustic feature vector having fixed-length numeric fields.

In some embodiments, the terminal executes a lightweight emotion-recognition model on the processor using an inference library for embedded devices. The terminal uses a feed-forward neural network consisting of an input layer receiving the acoustic feature vector, one or more hidden layers with nonlinear activation functions such as rectified linear units, and an output layer with a Softmax function producing a probability distribution over discrete emotion categories. The terminal stores resulting emotion scores in the memory as preliminary emotional state information associated with each utterance.

The terminal constructs a data packet that includes at least a user identifier, a timestamp, the character information produced by the speech recognition processing, the acoustic feature information, and the preliminary emotional state information. The terminal serializes the packet using a structured data format such as a generic text-based format or a binary format. The terminal encrypts the serialized data using a cryptographic module implementing a secure transport protocol and transmits the encrypted packet to the server using the communication interface.

The server receives the packet via the network interface. The server executes a communication framework such as a web application framework on the processor and terminates a secure communication session. The server decrypts and deserializes the packet to obtain structured internal representations of the character information, the acoustic feature information, and the preliminary emotional state information. The server stores these representations in a database management system such as a relational database or a document database in the storage unit, associating each record with the user identifier and the timestamp.

The server executes natural language processing on the character information. The server uses a morphological analysis tool or a syntactic analysis tool to tokenize sentences and assign part-of-speech tags and dependency relations. The server uses a transformer-based model, such as a bidirectional encoder representation model fine-tuned for intent classification, to estimate an utterance intention. The server converts tokens into indices using a tokenizer, forms input tensors including input identifiers and attention masks, and supplies the tensors to the intent model executed on the processor. The server obtains an embedding from a designated token position, passes the embedding through a dense layer and a Softmax function, and determines an utterance intention label and associated probabilities. The server executes emotion estimation processing on the character information. The server uses a transformer-based emotion classification model, different from or jointly trained with the intent model, and processes the tokenized character information to obtain text-based emotional state scores. The server applies a Softmax function to logits corresponding to emotion categories and stores the resulting probabilities in the memory.

The server integrates the preliminary emotional state information from the terminal with the text-based emotional state scores. The server applies a weighting scheme, for example assigning a first weight to acoustic-based scores and a second weight to text-based scores, and computes a weighted sum for each emotion category. The server selects a category having the highest integrated score as a dominant emotional state and may map the numeric score to a qualitative descriptor such as “slightly anxious” or “strongly depressed.” By fusing acoustic and textual emotion signals in a systematic mathematical form, the server reduces classification variance and increases robustness compared to systems using only a single modality.

The server executes a health state determination model implemented using a machine learning framework such as a tree-based ensemble library or a neural network library. The server concatenates the acoustic feature information and the integrated emotional state information into a combined feature vector. The server normalizes each dimension using pre-computed mean and standard deviation values obtained during training. The server inputs the normalized feature vector to a machine learning model such as a random forest, a gradient boosting model, or a neural network architecture that may include fully connected layers, recurrent units, or temporal convolution layers for handling sequences in an extended embodiment. The server obtains output values representing probabilities or scores for health-related states, such as a depression risk level, a neurodegenerative disorder risk level, or a cognitive decline risk level. The server compares these values with threshold values stored in the memory and determines a health state determination result that includes at least presence or degree of an abnormality.

The server executes prompt generation processing to construct a prompt sentence for a generative AI model. The server maintains internal state variables including the utterance intention, the integrated emotional state, the health state determination result, user attribute information such as age group and preferences, and environment information such as current facility schedule or time of day. The server selects a prompt template according to the utterance intention. For example, the server selects a schedule-explanation template when the intention indicates a question about facility activities, and selects an empathy-support template when the intention indicates a complaint about low mood and the emotional state indicates a depressive tendency.

The server inserts specific values into placeholders of the selected template, thereby constructing a natural language prompt sentence that encodes constraints and instructions to the generative AI model. For example, when the user asks about daily activities and the integrated emotional state indicates that the user is slightly anxious, the server generates a prompt sentence such as:

“You are a conversational agent for elderly residents in a care facility.

The user is feeling slightly anxious and is asking about today's activities in the facility. Please explain today's activities in a calm and gentle tone so that the user can feel reassured. Avoid difficult technical terms and use positive and soothing expressions.

Today's activity schedule is as follows:
10:00 Exercise class (dining hall)
14:00 Gardening club (courtyard)
16:00 Tea-time social gathering (lounge)

The user's question is: ‘ [symbol] ?’”

In another example, when the health state determination result indicates a sustained high depression risk, the server generates a prompt sentence for staff notification such as:

“Based on the following information, please create an alert message for care staff.
Target resident: Mr./Ms. A
Situation: For the past two weeks, the ‘depression’ emotion score estimated from conversations has been continuously above 0.7.
Voice features: During the same period, speech rate has decreased by about 30%, and overall voice tone has become lower.
Possible risks: Worsening of depressive state, potential decline in cognitive function. In the message, please describe (1) an overview of the detected abnormality, (2) possible risks, and (3) recommended next actions (such as consulting a physician, increasing supportive conversations with the resident, and considering contacting family). Use concise and polite Japanese suitable for professional care staff.”

The server calls a generative AI model using the prompt sentence. The server uses a client library or an HTTP client to send the prompt sentence and generation parameters, such as maximum output length and sampling temperature, to a generative AI model endpoint. The generative AI model is implemented as a neural network architecture, such as a transformer-based language model including a stack of self-attention layers and feed-forward layers. During generation, the generative AI model encodes the prompt sentence and iteratively computes distributions over next tokens, selecting tokens according to the specified decoding strategy. The server receives a dialogue response sentence or notification text generated by the generative AI model and may perform post-processing, such as ensuring removal of medical diagnoses and truncating overly long responses.

The server outputs the dialogue response sentence to the terminal via the network interface. The terminal receives the dialogue response sentence and executes text-to-speech synthesis using a speech synthesis engine. The terminal configures the speech synthesis parameters, such as speech rate and voice style, according to metadata provided by the server or according to the emotional state. For example, the terminal may lower the speech rate and select a softer voice parameter when the server indicates that the user is anxious or depressed. The terminal outputs the synthesized audio through the speaker so that the user receives a spoken response. When the health state determination result indicates an abnormality, the server executes notification generation processing. The server constructs a prompt sentence for the generative AI model that includes the abnormality content, assumed risks, and recommended action categories. The server may tailor the prompt sentence differently depending on whether the notification is directed to a care worker or a family member, for example by specifying different levels of technical detail and tone. The server sends the prompt sentence to the generative AI model, receives a notification text, and then sends the notification text to external information processing apparatuses such as staff terminals or family terminals by using an electronic messaging system or a push notification service.

The server stores, in the storage unit, records including the character information, the acoustic feature information, the integrated emotional state, the health state determination result, the prompt sentences, and the generated outputs. The server periodically performs long-term analysis. The server retrieves sequences of historical records for each user and computes time-series metrics such as trends in average fundamental frequency, trends in speech rate, and changes in depression-related emotion scores. The server uses a long-term health state model, which may be implemented as a recurrent neural network or a tree-based ensemble taking time-aggregated features as input, to derive long-term risk scores. The server merges short-term abnormality detection results and long-term risk scores when deciding whether to generate notifications. This multi-scale analysis improves detection of gradual changes that would be difficult to notice in a single human observation.

From a technical perspective, the described configuration improves computer technology in several ways. The server and terminal implement specific data structures and processing pipelines that cause a fusion of acoustic features, textual content, emotion scores, and health risk outputs to be used programmatically in constructing prompt sentences for the generative AI model, rather than relying on static or manually generated prompts. Because the prompt generation processing systematically encodes internal state variables and environment information into the prompt sentence, the generative AI model produces outputs that are more consistent, more controllable, and less likely to deviate from required constraints. This reduces the need for repeated human intervention, decreases error due to inconsistent prompting, and improves computational efficiency by avoiding unnecessary or irrelevant generations.

The use of machine learning models for emotion estimation and health state determination introduces specific decision boundaries and probabilistic thresholds that differ from human subjective judgment. The server executes these models using optimized numerical computation libraries, allowing real-time or near-real-time inference even when multiple users are handled concurrently. The fusion of voice-based and text-based emotion scores reduces false positives and false negatives compared to systems using a single modality, thereby improving the precision and recall of emotion classification. This, in turn, enables the server to construct more appropriate prompt sentences, which leads to more accurate and context-aware outputs from the generative AI model.

By recording and aggregating long-term interaction data, the server can detect subtle temporal patterns using algorithms that are not practically feasible for human observers. The server performs automated trend analysis using statistical and machine learning methods, and the resulting long-term risk evaluation allows the system to adjust thresholds and behavior in a data-driven manner. For example, when the server observes a consistent decrease in speech rate and increase in depression scores over several weeks, the server can lower alert thresholds and generate notifications earlier. This adaptive behavior improves system responsiveness and reduces the probability that important signals are overlooked. The architecture allows various alternative embodiments and variations. The terminal may offload speech recognition to the server or may execute all front-end processing locally depending on available resources. The emotion estimation processing may rely solely on server-side models, solely on terminal-side models, or on a combination of both, and weighting factors for fusion may be dynamically adjusted according to reliability metrics. The health state determination model may be implemented using different algorithms such as support vector machines, convolutional neural networks for spectrogram images, or hybrid models combining temporal and static features. The generative AI model may be deployed as a cloud service, an on-premises server, or a dedicated inference appliance.

In all such embodiments, the server and terminal execute concrete, structured algorithms, data flows, and model inferences that transform raw sensor input into high-level state variables and then into carefully controlled prompt sentences for a generative AI model. The described combination of modules improves the operation of the computing system itself, achieving improved detection accuracy, reduced latency in processing, enhanced control over generated content, and better management of large volumes of multimodal data, and thereby provides technical effects beyond a mere automation of human communication tasks.

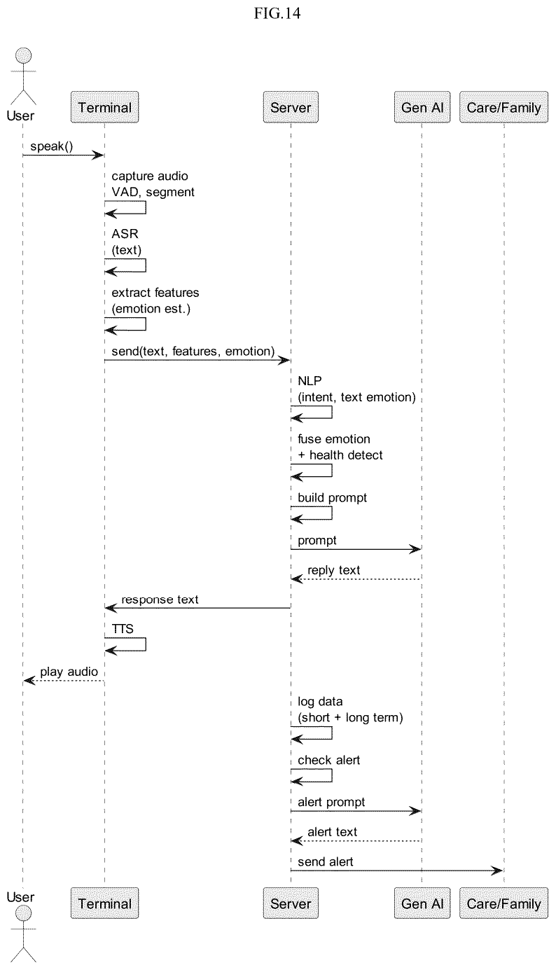

The following describes the processing flow using FIG. 14.

### Step 1:

The user produces natural speech in front of the terminal and provides an utterance as input sound.

The terminal receives analog audio from the microphone and uses an operating-system audio API to sample the audio at a predetermined sampling rate (for example, 16 kHz, 16-bit PCM). The terminal writes the sampled values into an audio buffer in memory. Based on this input, the terminal applies a voice activity detector that compares frame-wise energy and zero-crossing rate to thresholds and thereby detects start and end points of speech segments.

The terminal outputs segmented acoustic information representing at least one utterance as a digital audio clip.

### Step 2:

The terminal receives the segmented acoustic information as input and performs speech recognition processing.

The terminal divides the audio clip into overlapping frames (for example, 25 ms frame length, 10 ms frame shift) and applies a window function such as a Hamming window to each frame. The terminal executes a Fast Fourier Transform on each frame to obtain a magnitude spectrum, applies a mel filterbank to convert the spectrum into mel-scale energies, and computes mel-frequency cepstral coefficients for each frame. The terminal normalizes the coefficients using precomputed mean and variance values and inputs the coefficient sequence to an acoustic model implemented as a neural network (for example, a recurrent neural network or a time-delay neural network). The terminal obtains posterior probabilities over phonetic or subword units per frame and then executes a decoding algorithm that combines these probabilities with a language model, such as an n-gram model, to search for the most likely text sequence. The terminal outputs character information representing the recognized content of the user's utterance.

### Step 3:

The terminal receives the segmented acoustic information as input and calculates acoustic feature information.

The terminal uses a digital signal processing library to compute low-level descriptors such as fundamental frequency, short-time energy, spectral centroid, spectral bandwidth, and mel-frequency cepstral coefficients for each frame. The terminal then performs data aggregation by calculating statistics (for example, mean, standard deviation, minimum, maximum) over all frames of the utterance for each descriptor. The terminal additionally calculates derived quantities such as speech rate by dividing the number of linguistic units derived from the character information by the total voiced duration, and pause ratio by dividing the total silence duration by the entire segment length. Based on these computations, the terminal outputs an acoustic feature vector containing fixed-length numeric fields that summarize the utterance.

### Step 4:

The terminal receives the acoustic feature vector as input and optionally performs local emotion estimation processing.

The terminal loads a lightweight neural network model into memory, where the network consists of an input layer corresponding to the dimensions of the acoustic feature vector, one or more hidden layers with nonlinear activation functions, and an output layer with a Softmax activation. The terminal supplies the acoustic feature vector to the model and executes forward propagation, computing weighted sums and activations at each layer. From the Softmax output, the terminal obtains a probability distribution over discrete emotion categories such as joy, anxiety, depression, anger, and neutral. The terminal outputs preliminary emotional state information in the form of emotion probabilities associated with the utterance.

### Step 5:

The terminal receives the character information, the acoustic feature vector, and the preliminary emotional state information as input and constructs a transmission packet. The terminal generates a structured object that includes at least a user identifier, a timestamp, the character information, the acoustic feature vector, and the preliminary emotional state information. The terminal serializes this object using a predefined format and then applies encryption using a security protocol stack. Based on this processed data, the terminal sends the resulting encrypted packet as output to the server via a network connection.

### Step 6:

The server receives the encrypted packet as input and performs communication and storage processing.

The server accepts the packet through a network interface, uses a protocol stack to terminate a secure session, and decrypts the payload. The server deserializes the payload into internal data structures containing the character information, the acoustic feature information, and the preliminary emotional state information. The server associates this data with the corresponding user identifier and timestamp and writes the data into a persistent storage unit such as a database table or a document collection. The server outputs structured internal objects that are ready for further analysis.

### Step 7:

The server receives the character information as input and executes natural language processing to estimate an utterance intention.

The server uses a morphological analyzer to segment the character information into tokens and assign part-of-speech tags. The server then applies a transformer-based intent classification model by converting the tokens into numeric indices, forming input tensors (input identifiers and attention masks), and running forward propagation through multiple self-attention and feed-forward layers. The server extracts an embedding vector from a designated position (for example, a classification token), applies a dense layer and a Softmax function, and calculates probabilities for several intent categories, such as facility-schedule inquiry, health consultation, small talk, and assistance request. The server selects the highest-probability label as the utterance intention and outputs the intention label and its probability distribution.

### Step 8:

The server receives the character information as input and performs text-based emotion estimation processing.

The server uses a transformer-based emotion recognition model that shares or mirrors the architecture of the intent model but has an output layer configured for emotion categories. The server tokenizes the character information, produces input tensors, and executes the model. The server obtains logits for each emotion category and applies a Softmax function to produce normalized probabilities. From these probabilities, the server outputs text-based emotional state information describing the likelihood of each emotion category.

### Step 9:

The server receives the preliminary emotional state information from the terminal and the text-based emotional state information from the emotion estimation model as input, and integrates them into a unified emotional state.

The server aligns emotion categories between the two sets of scores and assigns weighting coefficients, such as a first weight for voice-based scores and a second weight for text-based scores. For each emotion category, the server performs a weighted average computation of the corresponding probabilities, thereby generating integrated scores. The server selects the emotion category with the largest integrated score and optionally converts the numeric score into a graded descriptor (for example, slightly anxious or strongly depressed). The server outputs an integrated emotional state consisting of the category label and the integrated scores.

### Step 10:

The server receives the acoustic feature vector and the integrated emotional state as input and determines a health state determination result.

The server concatenates the acoustic feature vector and the integrated emotional scores into a combined feature vector of predetermined length. The server normalizes each element based on pre-stored scaling parameters and then inputs the normalized vector into a health state determination model implemented with machine learning algorithms, such as an ensemble of decision trees, a neural network, or a hybrid architecture. The server executes the model to compute output scores representing risk levels for various health-related states (for example, depression risk, neurodegenerative disorder risk, cognitive decline risk), and compares these scores with defined thresholds. Based on this comparison, the server determines whether there is an abnormality and, if so, its degree, and outputs the health state determination result as labels and associated scores.

### Step 11:

The server receives as input the utterance intention, the integrated emotional state, the health state determination result, and context information including user attribute information and environment information, and generates a prompt sentence for a generative AI model. The server selects a prompt template based on the utterance intention and constructs a textual description specifying the role of the generative AI model, the emotional condition of the user, and constraints on style and content. The server inserts into the template specific data items such as the current facility schedule, the user's recent dialogue history, and the health state determination result. The server thereby performs string concatenation and placeholder substitution operations to create a coherent natural language prompt sentence. The server outputs the constructed prompt sentence as input for the generative AI model.

### Step 12:

The server receives the prompt sentence as input and obtains a dialogue response sentence from the generative AI model.

The server uses a client interface to send the prompt sentence and generation parameters, such as maximum token count and temperature, to the generative AI model. The generative AI model tokenizes the prompt sentence, executes a transformer-based generation process to compute probability distributions of the next token at each step, and samples or selects tokens until an end condition is met. The server receives the generated token sequence and converts it back into text as a dialogue response sentence. The server optionally performs post-processing such as removing content outside allowed topics or limiting length, and then outputs the final dialogue response sentence.

### Step 13:

The server receives the dialogue response sentence and the health state determination result as input and prepares response data for the terminal.

The server constructs a response structure that contains the dialogue response sentence and optional metadata, such as recommended speech rate, voice style, or language settings derived from the integrated emotional state and the health state determination result. The server serializes this structure and sends it through a secure communication channel to the terminal. The server outputs the serialized response data as a network message.

### Step 14:

The terminal receives the response data as input and generates audio output to the user. The terminal parses the response data to extract the dialogue response sentence and the metadata, and then passes the text to a text-to-speech engine. The terminal configures the engine using the metadata, for example adjusting speech rate and voice timbre according to the user's emotional state. The terminal instructs the engine to synthesize an audio waveform from the text, receives the waveform buffer, and sends it to the audio output API. The terminal outputs the waveform through the speaker as audible speech for the user.

### Step 15:

The server receives the character information, the acoustic feature information, the integrated emotional state, the health state determination result, the prompt sentence, and the dialogue response sentence as input and performs logging and long-term analysis preparation. The server creates a log record that includes these data elements along with a timestamp and user identifier, and the server writes this record into a persistent storage structure. The server thereby accumulates time-series data for each user. The server later reads sequences of such records and performs statistical computations such as calculating moving averages, slopes, and variance over time for selected features, and produces time-series feature vectors as output for long-term health state modeling.

### Step 16:

The server receives outputs from long-term analysis and the current health state determination result as input and generates notification information when necessary.

The server evaluates combined indicators from short-term results and long-term trends against defined rules or thresholds. When the server detects that an abnormal condition meets or exceeds a threshold, the server constructs a prompt sentence directed toward generation of notification content. The server specifies in the prompt sentence details such as measured changes in emotion scores and speech rate, possible risks, and required elements of an explanation and recommended actions. The server submits this prompt sentence to the generative AI model, receives generated notification text, and formats it into a notification message targeted to external information processing apparatuses such as care worker terminals or family terminals. The server outputs the notification information through messaging channels and records that notification in the storage for traceability.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

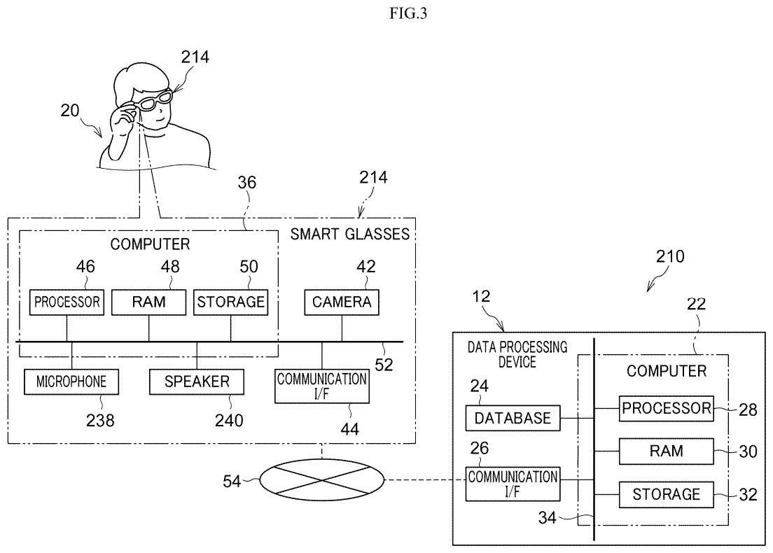

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

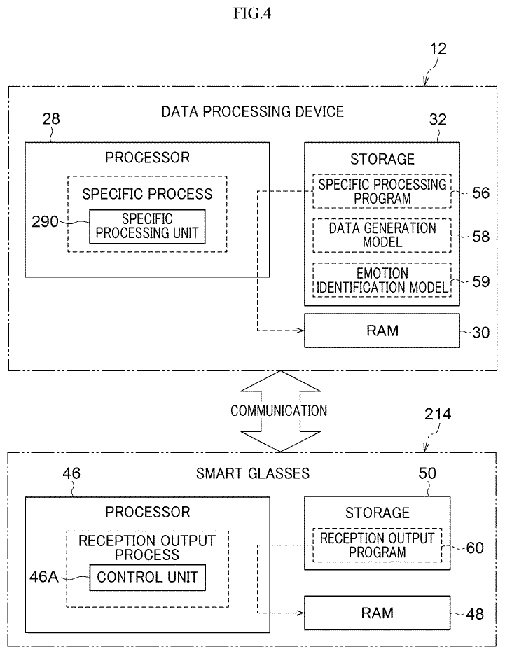

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

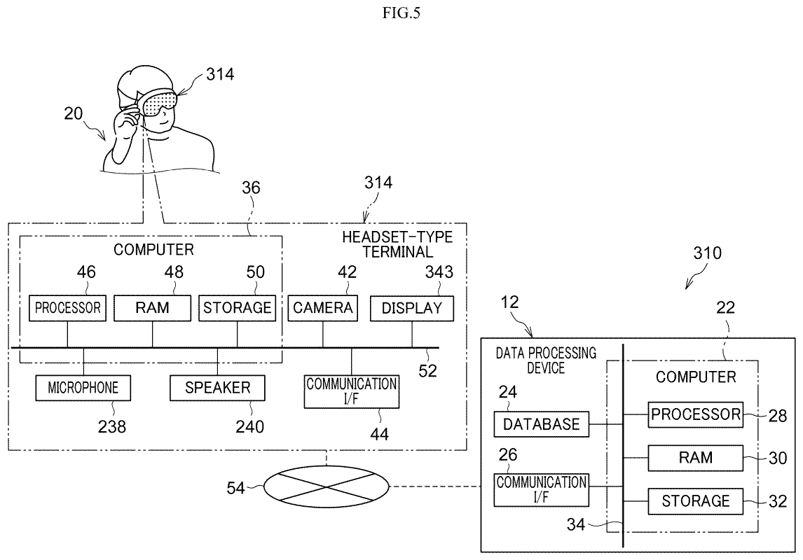

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

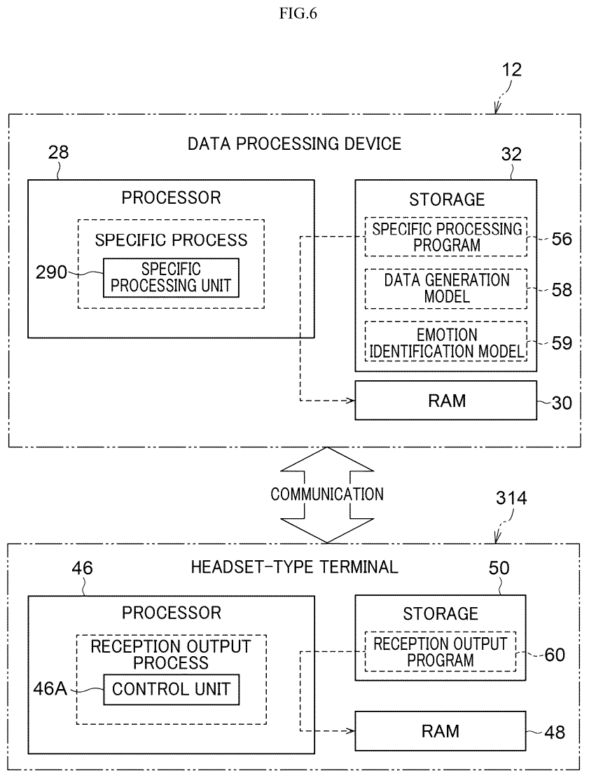

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

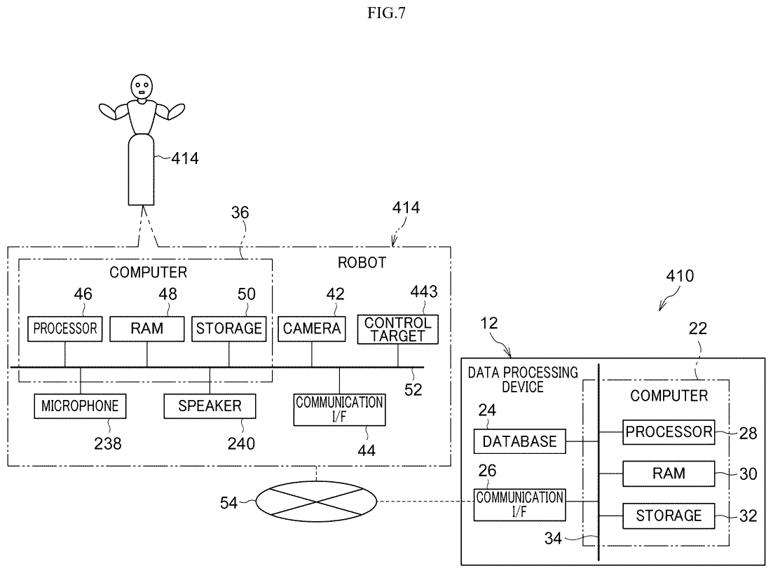

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

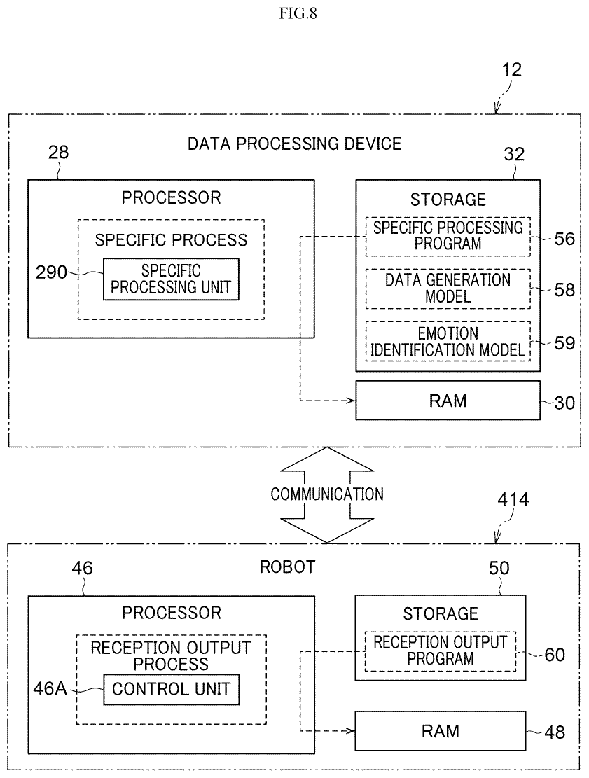

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

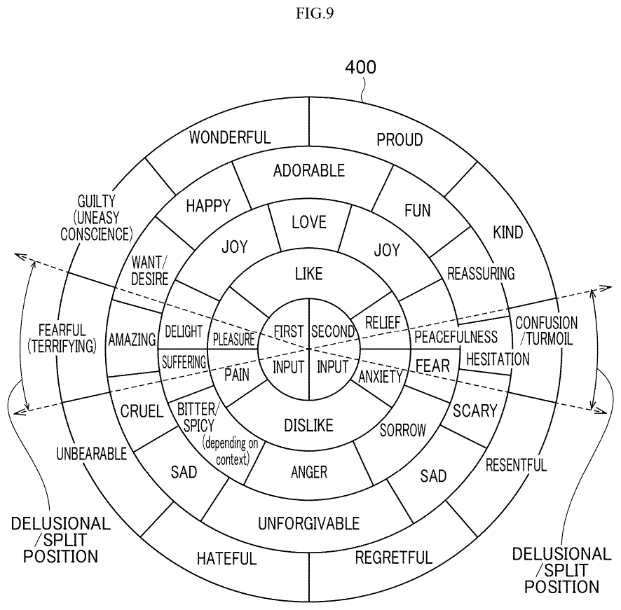

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

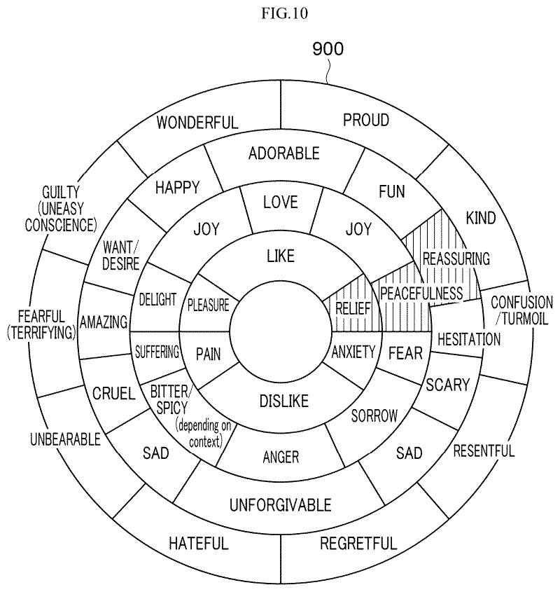

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
perform dialog processing that generates natural language responses based on user utterances, perform acoustic information collection that, in parallel with the dialog processing, extracts voice feature values from acoustic information of the user and records the voice feature values,
perform state analysis that applies a trained discrimination model to the recorded voice feature values and previously recorded voice feature values to calculate an abnormality index and to determine whether a health state of the user is abnormal,
perform notification processing that, when a determination result of the state analysis satisfies a predetermined condition, transmits notification information including abnormality contents and recommended response contents to at least one of a medical-related organization, a life-support providing organization, a monitoring-related organization, and a family terminal, perform generative response processing in which the dialog processing generates a prompt sentence including a task description, dialog history information, and user utterance text based on content of the user utterance and dialog history, and inputs the prompt sentence to a generative AI model to obtain a response text, perform explanation generation processing in which the state analysis generates an explanation prompt sentence based on an analysis result including the abnormality index and time-series transition information, and inputs the explanation prompt sentence to the generative AI model to obtain an expert-oriented explanation text and a family-oriented explanation text, and
perform transmission control processing in which the notification processing transmits, via a communication network, an alert message including the explanation texts obtained by the explanation generation processing.

### (Supplementary 2)

The system according to supplementary 1,
wherein the processor is configured to
cause the dialog processing, as the prompt sentence to be input to the generative AI model, to include control text that adds dialog policy information indicating that the user is an elderly person and that easy-to-understand expressions are to be used, thereby causing the generative AI model to generate at least one of topic presentation, news information, life information, and casual conversation in accordance with interests and concerns of the elderly person, and cause the acoustic information collection to continuously collect a plurality of types of voice feature values including fundamental frequency, sound volume, speech rate, speech rhythm, and voice quality stability, and provide the voice feature values to the state analysis.

### (Supplementary 3)

The system according to supplementary 1,
wherein the processor is configured to
cause the state analysis to execute time-series analysis processing using a machine learning algorithm on a sequence of the voice feature values acquired from the acoustic information collection, and to detect a pattern indicating a disease sign based on a variation amount relative to a reference value for each user and the abnormality index,
cause the explanation generation processing to generate a prompt sentence including contents instructing that, “based on the analyzed voice feature values and the abnormality index, describe detected abnormal tendencies in plain expressions without making a medical definitive diagnosis, and propose a recommended next response,” and to cause the generative AI model to generate, from the prompt sentence, an abnormality-content explanation text and a recommended-action proposal text, and
cause the notification processing to transmit notification information including the explanation text and the proposal text.

### Application Example 1

### (Supplementary 1)

A system comprising a processor,
wherein the processor is configured to
perform dialog processing to conduct a natural language dialog with an elderly person, the dialog processing including converting input audio information into character information, executing natural language processing on the character information, generating response character information, and converting the response character information into audio information for output,
generate, during the dialog processing, feature sequences based on time information for audio information obtained from the elderly person, extract acoustic feature values from the feature sequences, and store the acoustic feature values for each user and for each time series in a storage unit,
compare stored acoustic feature values with past acoustic feature values, use a machine learning model to calculate an abnormality degree related to a health condition of the elderly person, and generate disease risk information based on the abnormality degree, generate notification information data to be presented to a notification target based on the disease risk information and attribute information, behavior information, and location information related to the elderly person,
generate a prompt sentence including at least the disease risk information and the attribute information related to the elderly person, input the prompt sentence to a generative AI model, and acquire explanation character information from the generative AI model,
generate notification messages for a care service provider terminal and a family terminal based on the explanation character information and the notification information data, and transmit the notification messages via a communication network, and
control execution availability of the storage of the acoustic feature values and the calculation of the abnormality degree based on consent information from the elderly person or a family member, and perform deletion or anonymization of stored information in accordance with a change of the consent information.

### (Supplementary 2)

The system according to supplementary 1,
wherein the processor is configured to
generate a prompt sentence including character information obtained from the elderly person, attribute information related to the elderly person, and schedule information related to a facility, input the prompt sentence to the generative AI model to generate the response character information, and, when generating the response character information, generate a personalized response including guidance information based on interest information of the elderly person and past dialog history information.

### (Supplementary 3)

The system according to supplementary 1,
wherein the processor is configured to
generate a baseline profile for each user based on acoustic feature values and reference values calculated from the acoustic feature values over a predetermined period, calculate, based on a deviation from the baseline profile, a plurality of risk indices indicating disease risks, generate alert information including at least a classification of notification targets, recommended response actions, and notification priority based on the risk indices and past notification results, generate a prompt sentence including the risk indices and the alert information, input the prompt sentence to the generative AI model, and generate explanation character information including an explanation text for a care service provider and a family member based on an output from the generative AI model.

### Example 2

### (Supplementary 1)

A system comprising a processor,
wherein the processor is configured to
perform dialogue processing that conducts a natural-language conversation with a user based on utterance content of the user,
collect audio data by acquiring an audio signal as time-series data from an audio input device installed in proximity to the user and performing sampling processing and frame division processing on the audio signal,
generate character information by performing speech recognition processing on the audio signal and converting the audio signal into text data representing the utterance content, extract audio feature values by performing frequency analysis and statistical analysis on the audio signal, the audio feature values including at least a fundamental frequency, a sound volume, a speaking rate, a frequency spectrum, and a voice tremor index, and construct an audio feature vector as a numerical vector from the audio feature values,
estimate an emotional state of the user by inputting the character information to a language representation model to generate a text embedding vector representing semantic features, generating an audio feature vector from the audio feature values, combining the text embedding vector and the audio feature vector into a multidimensional feature vector, and inputting the multidimensional feature vector to an emotion classification model, determine a health state of the user by applying a machine learning model to time-series data of the audio feature values and the emotional state, and by calculating, based on statistical values and occurrence frequencies in a predetermined period, presence or absence of an abnormality relating to a health state of the user or a disease risk score of the user,
generate a response-oriented prompt sentence as natural-language text by using the character information and the emotional state, the response-oriented prompt sentence including response conditions for the user and being configured as input text for a generative AI model, generate a notification-oriented prompt sentence as natural-language text by using an abnormality determination result obtained by the health state determination and the emotional state, the notification-oriented prompt sentence including notification conditions for an external recipient and time-series statistical information of the audio feature values and the emotional state, and being configured as input text for the generative AI model,
cause the generative AI model to generate, based on at least one of the response-oriented prompt sentence and the notification-oriented prompt sentence, a response text for the user or a notification text for an external recipient,
convert the response text into an audio signal by performing speech synthesis processing and output the audio signal, and
transmit the notification text via a communication network to a terminal of a medical service provider or a terminal of a family member.

### (Supplementary 2)

The system according to supplementary 1,
wherein the processor is configured to
change the response conditions in the response-oriented prompt sentence in accordance with the emotional state estimated by the emotion classification model, specify at least one tone selected from an encouraging tone, a reassuring tone, and an alerting tone, and cause the generative AI model to generate, in accordance with the specified tone, a natural-language response text for the user.

### (Supplementary 3)

The system according to supplementary 1,
wherein the processor is configured to
calculate the disease risk score from time-series feature values including at least a speaking rate, a fundamental frequency, a voice tremor index, and an occurrence frequency of emotional labels indicating a depressive state or an anxious state over the predetermined period, determine that an abnormal health condition is suspected when the disease risk score exceeds a threshold value, generate, in such a case, the notification-oriented prompt sentence including the time-series feature values and the disease risk score and including a condition that a diagnosis is not performed and that a recommendation for medical consultation is presented, and cause the generative AI model to generate, based on the notification-oriented prompt sentence, the notification text for the medical service provider or the family member.

### Application Example 2

### (Supplementary 1)

A system comprising a processor,
wherein the processor is configured to
perform dialogue control processing that generates a natural language dialogue response on the basis of utterance information of a user,
acquire acoustic information of the user by performing voice information acquisition processing on the utterance information of the user,
calculate acoustic feature information by performing acoustic feature calculation processing on the acoustic information,
generate character information by performing speech recognition processing on the acoustic information,
estimate an utterance intention of the user by performing natural language processing on the character information,
estimate an emotional state of the user on the basis of at least one of the acoustic feature information and the character information by using emotion estimation processing,
determine presence or degree of an abnormality in a health state of the user by executing a machine learning model that receives as input at least one of the acoustic feature information and the emotional state,
generate a prompt sentence to be input to a generative AI model by performing prompt generation processing based on the utterance intention, the emotional state, a health state determination result obtained by the machine learning model, and at least part of attribute information of the user or environment information,
input the prompt sentence to the generative AI model to cause the generative AI model to generate a dialogue response sentence, and present the dialogue response sentence to the user by performing response generation processing, and
generate notification information including at least abnormality content, an assumed risk, and a recommended action, and transmit the notification information to an external information processing apparatus when the abnormality in the health state of the user is detected, by performing notification generation processing.

### (Supplementary 2)

The system according to supplementary 1,
wherein the processor is configured to
cause the dialogue control processing to include, in the prompt sentence to be input to the generative AI model, the emotional state of the user, abnormality presence information determined by the machine learning model regarding the health state of the user, and context information based on at least one of a past dialogue history and a past behavior history, so that the generative AI model generates the dialogue response sentence whose tone and content are adjusted in consideration of the emotional state of the user.

### (Supplementary 3)

The system according to supplementary 1,
wherein the processor is configured to
cause the notification generation processing to input to the generative AI model a prompt sentence including at least one of a short-term abnormality detection result by the machine learning model and a long-term risk evaluation result calculated on the basis of temporal changes of at least one of the acoustic feature information, the emotional state, and the character information, so that the generative AI model automatically generates the notification information including an explanation sentence and a recommended action, the explanation sentence and the recommended action being adjusted in expression for at least one of a care worker and a family member.

What is claimed is:

1. A system comprising:
circuitry configured to:
perform dialog processing with a user by generating natural language responses based on user utterances received via a communication interface coupled to a packet-switched network;
extract voice feature values from audio data of the user obtained during the dialog processing, the voice feature values including at least one of fundamental frequency, volume, speech rate, rhythm, and voice quality stability;
apply a trained classification model and time-series analysis to the extracted voice feature values and historical voice feature values stored in a storage device to calculate an abnormality index; and
transmit notification data to one or more external terminal devices via the communication interface when the abnormality index satisfies a predetermined condition.

2. The system according to claim 1, wherein the circuitry generates the natural language responses by constructing a prompt data structure encoding a task description, dialog history information, and text of the user utterances, and transmitting the prompt data structure to a generative neural network model comprising a transformer-based architecture with a plurality of self-attention layers to obtain response text.

3. The system according to claim 2, wherein the circuitry selects dialog topics based on interest profile data and concern profile data associated with the user stored in the storage device, and incorporates the selected topics into the prompt data structure to maintain engaging and contextually relevant conversation.

4. The system according to claim 3, wherein the circuitry updates the interest profile data and the concern profile data based on content analysis of the user utterances across a plurality of dialog sessions, and adjusts topic selection frequency to prioritize topics that elicit longer and more detailed responses from the user.

5. The system according to claim 4, wherein the circuitry converts the response text into synthesized audio data using a speech synthesis model and transmits the synthesized audio data to a terminal device of the user via the communication interface to conduct the dialog as a voice conversation.

6. The system according to claim 1, wherein the circuitry extracts the voice feature values in parallel with the dialog processing by performing signal processing on the audio data including segmentation into utterance intervals, spectral analysis, and prosodic feature computation.

7. The system according to claim 6, wherein the voice feature values further include mel-frequency cepstral coefficients, jitter, shimmer, and harmonic-to-noise ratio, and wherein the circuitry stores the extracted voice feature values in the storage device in association with timestamp information and session identifiers.

8. The system according to claim 7, wherein the circuitry computes aggregated voice feature statistics including mean, variance, and trend slope for each voice feature value across a sliding window of historical dialog sessions, and stores the aggregated statistics in the storage device for use in the time-series analysis.

9. The system according to claim 1, wherein the trained classification model comprises a neural network trained on labeled voice feature data to discriminate between normal and abnormal voice patterns, and wherein the time-series analysis detects deviations from baseline voice feature trajectories computed from the historical voice feature values.

10. The system according to claim 9, wherein the circuitry calculates the abnormality index as a weighted combination of the classification model output and the time-series deviation magnitude, and compares the abnormality index against a plurality of threshold levels corresponding to different severity categories.

11. The system according to claim 10, wherein the circuitry further classifies a type of detected abnormality based on which voice feature values contribute most to the abnormality index, and associates the classified type with known condition categories stored in the storage device to generate condition-specific notification data.

12. The system according to claim 1, wherein the notification data includes at least abnormality details, a recommended response action, and location information of the user, and wherein the circuitry transmits the notification data to at least one of a medical institution terminal, a care service terminal, and a monitoring service terminal.

13. The system according to claim 12, wherein the circuitry generates explanation text by constructing an explanation prompt data structure encoding the abnormality index, time-series transition information, and contributing voice feature values, transmitting the explanation prompt data structure to the generative neural network model, and receiving from the generative neural network model a first explanation text formatted for professional recipients and a second explanation text formatted for family recipients.

14. The system according to claim 1, wherein the circuitry schedules dialog sessions with the user at periodic intervals, and adjusts a frequency and duration of the dialog sessions based on a trend of the abnormality index over time, increasing session frequency when the abnormality index shows an upward trend.

15. The system according to claim 14, wherein the circuitry receives feedback data from the one or more external terminal devices indicating an outcome assessment of previous notifications, and updates the trained classification model and the predetermined condition thresholds based on the feedback data.

16. The system according to claim 1, wherein the circuitry estimates an emotional state of the user based on the extracted voice feature values including pitch variation, speech rate changes, and volume fluctuations during the dialog processing.

17. The system according to claim 16, wherein the circuitry adjusts the dialog processing based on the estimated emotional state by modifying the prompt data structure to generate empathetic and calming responses when the estimated emotional state indicates distress, and generating encouraging and stimulating responses when the estimated emotional state indicates low engagement.

18. A system comprising:
a communication interface including a network interface controller coupled to a packet-switched network and configured to transmit and receive data packets;
a memory storing instructions, a generative neural network model comprising a transformer architecture with a plurality of self-attention layers, a trained classification model for voice pattern analysis, a speech synthesis model, and historical voice feature data; and
circuitry comprising one or more processors coupled to the memory and configured to execute the instructions to:
perform dialog processing with a user by constructing prompt data structures and transmitting the prompt data structures to the generative neural network model to generate natural language responses;
extract voice feature values from audio data of the user obtained during the dialog processing, the voice feature values including fundamental frequency, volume, speech rate, rhythm, and voice quality stability;
store the extracted voice feature values in association with timestamp information in a storage device;
apply the trained classification model and time-series analysis to the extracted voice feature values and the historical voice feature data to calculate an abnormality index;
transmit notification data including abnormality details and recommended response actions to one or more external terminal devices via the communication interface when the abnormality index satisfies a predetermined condition; and
generate explanation text by transmitting an explanation prompt data structure to the generative neural network model.

19. The system according to claim 18, wherein the circuitry is further configured to estimate an emotional state of the user based on the extracted voice feature values, and to adjust the dialog processing by modifying the prompt data structures based on the estimated emotional state.

20. A method performed by circuitry of a server coupled to a packet-switched network via a communication interface, the method comprising:
performing dialog processing with a user by generating natural language responses based on user utterances received via the communication interface;
extracting voice feature values from audio data of the user obtained during the dialog processing, the voice feature values including at least one of fundamental frequency, volume, speech rate, rhythm, and voice quality stability;
applying a trained classification model and time-series analysis to the extracted voice feature values and historical voice feature values stored in a storage device to calculate an abnormality index; and
transmitting notification data to one or more external terminal devices via the communication interface when the abnormality index satisfies a predetermined condition.
